(19) United States
(12) Patent Application Publication
(10) Pub. No.: US 2026/0252652 A1
(43) Pub. Date: Aug. 27, 2026

(54) SYSTEM

(71) Applicant: SoftBank Group Corp., Tokyo (JP)

(72) Inventor: Takeshi TSUBOUCHI, Tokyo (JP)

(73) Assignee: SoftBank Group Corp., Tokyo (JP)

(21) Appl. No.: 19/537,653

(22) Filed: Feb. 12, 2026

(30) Foreign Application Priority Data
Feb. 21, 2025 (JP) 2025-027070

(51) Int. Cl. G06F 16/9535; G06N 20/00

(52) U.S. Cl. CPC G06F 16/9535; G06N 20/00

(57) ABSTRACT

The system according to the embodiment comprises a collection unit, an extraction unit, a publication unit, a cooperation unit, an analysis unit, and a provision unit. The collection unit collects data. The extraction unit extracts an element from the data collected by the collection unit. The publication unit publishes the data extracted by the extraction unit on the Internet. The cooperation unit handles cooperation with a local government. The analysis unit analyzes, by AI, the data collected by the collection unit. The provision unit provides an analysis result obtained by the analysis unit.

### CROSS-REFERENCE TO RELATED APPLICATION

The present application claims priority to and incorporates by reference the entire contents of Japanese Patent Application No. 2025-027070 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, converting information such as local traditional performing arts, customs, and legends into data and widely publishing the data have not been sufficiently performed, and there is room for improvement.

### SUMMARY OF THE INVENTION

The system according to the embodiment comprises a collection unit, an extraction unit, a publication unit, a cooperation unit, an analysis unit, and a provision unit. The collection unit collects data. The extraction unit extracts an element from the data collected by the collection unit. The publication unit publishes the data extracted by the extraction unit on the Internet. The cooperation unit handles cooperation with a local government. The analysis unit analyzes, by AI, the data collected by the collection unit. The provision unit provides an analysis result obtained by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

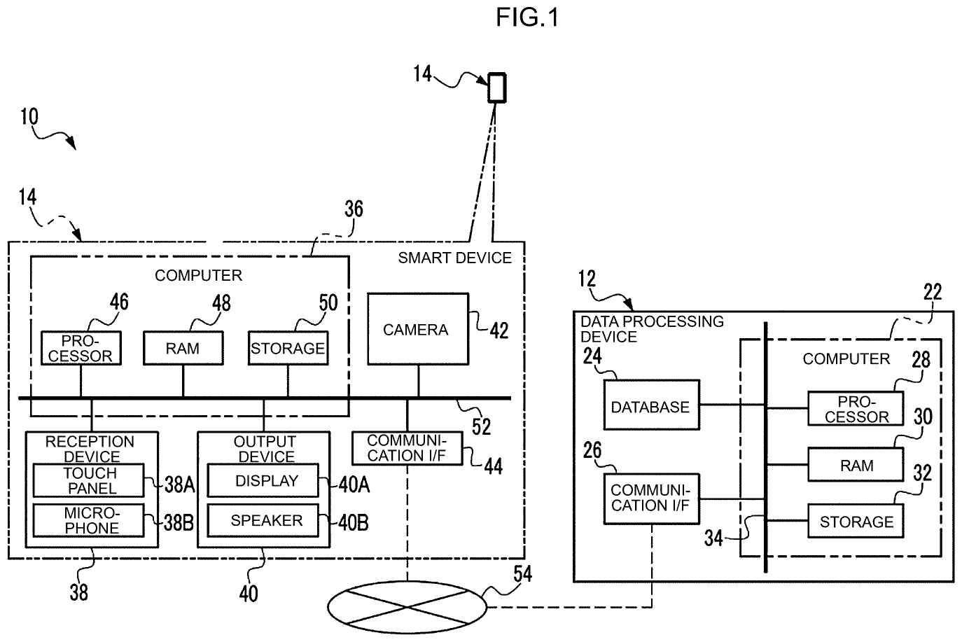

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

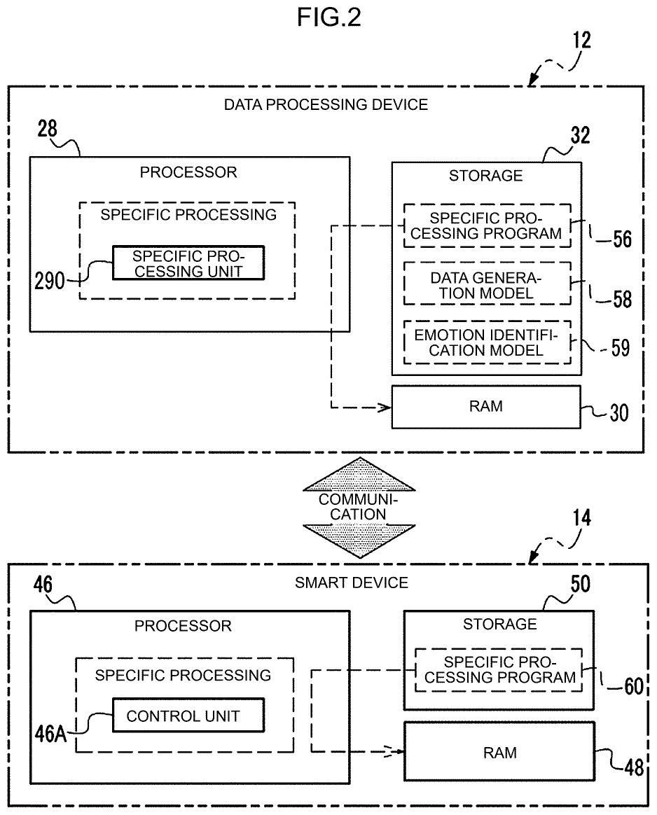

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The digital transformation (DX) promotion system according to the embodiment of the present invention is a system that utilizes the strengths of shops existing nationwide and supports data conversion necessary for all citizens to promote DX in all regions. First, this system collects region-specific information such as traditional performing arts, customs, and legends. This information is acquired by reading data such as images, audio, and videos from data sources on the Internet. Next, elements are extracted from the acquired data, and the data is published on the Internet. Thereby, all information in the world is converted into data, and the accuracy of AI improves. Furthermore, it cooperates with local governments to create a foundation for disseminating the charm of the region. For example, videos of traditional festivals in the region are collected, detailed information of the festivals is extracted from the videos, and published on the Internet. Thereby, people in other regions can also know about the festivals, and the charm of the region spreads. Also, the collected data is utilized as learning data for AI. Thereby, the accuracy of AI improves, and more advanced analysis and proposals become possible. For example, by the AI analyzing videos of traditional performing arts in a region and learning their characteristics, comparison and analysis with traditional performing arts in other regions become possible. With this system, all citizens can promote DX in all regions and create a foundation for disseminating the charm of the region. Thereby, the DX promotion system allows all citizens to promote DX in all regions and create a foundation for disseminating the charm of the region. Specifically, this system is equipped with a large-scale data processing infrastructure built on a distributed cloud computing environment, and implements a function to efficiently collect unstructured data from edge devices and local servers scattered throughout the country. This system applies deep learning models based on Convolutional Neural Networks (CNN) or Transformer architectures to collected image data (e.g., 3D tensors consisting of pixel values), audio data (e.g., time-series amplitude value vectors), and text data (e.g., token ID sequences) to perform mapping to a high-dimensional feature space. This system quantifies region-specific cultural elements (e.g., movement patterns of festivals, prosodic features of dialects, visual textures of traditional crafts) using these feature quantities and stores them in a structured database as a Knowledge Graph. In the AI learning process by this system, collected multimodal data is used as input, and by using Self-Supervised Learning or Contrastive Learning, latent representations capable of identifying similarities and differences between regions with high precision are acquired while reducing labeling costs. For example, by using video data of Kagura in a certain region as input (image tensor sequence for each frame), a motion recognition model analyzes dance patterns and outputs motion labels such as “rotation” and “jump” and their probability scores, thereby enabling quantitative comparison with Kagura in other regions. With such a technical configuration, this system not only aggregates information but also converts regional culture into digital assets in a format understandable by computers, and achieves the effect of realizing advanced information processing such as correlation analysis between heterogeneous data and discovery of new tourism resources.

The DX promotion system according to the embodiment comprises a collection unit, an extraction unit, a publication unit, a cooperation unit, an analysis unit, and a provision unit. The collection unit collects data. The collection unit collects data from, for example, a data source on the Internet. The collection unit can collect data from, for example, news sites, SNS, blogs, and the like. The collection unit can also collect data from, for example, Yahoo or messenger apps. The extraction unit extracts an element from the collected data. The extraction unit extracts elements such as keywords, feature quantities, and patterns from the collected data, for example. The extraction unit can extract keywords from text data using natural language processing technology, for example. The publication unit publishes the extracted data on the Internet. The publication unit publishes data using platforms such as websites, SNS, and databases, for example. The publication unit can, for example, post data on a website so that anyone can access it. The cooperation unit handles cooperation with a local government. The cooperation unit, for example, implements a joint project with a local government and collects and publishes data for disseminating the charm of the region. The cooperation unit can, for example, perform API cooperation with a local government to share data. The analysis unit analyzes the collected data by AI. The analysis unit analyzes data using technologies such as machine learning, deep learning, and natural language processing, for example. The analysis unit can, for example, have the AI analyze the collected data and extract features of the data. The provision unit provides an analysis result. The provision unit provides the analysis result in a format such as a report, a graph, or statistical data, for example. The provision unit can, for example, post the analysis result on a website so that anyone can access it. Thereby, the DX promotion system according to the embodiment can efficiently perform collection, extraction, publication, cooperation, analysis, and provision of data. Specifically, each unit of this system is implemented as an independent container based on a microservices architecture and is managed by an orchestration tool such as Kubernetes. The present collection unit is composed of a Web crawler and a group of API connectors, and has a function of issuing HTTP requests in parallel to acquire HTML documents or JSON objects and inputting them into a distributed message queue (e.g., Kafka). The present extraction unit includes a natural language processing (NLP) engine and an image recognition engine, performs Named Entity Recognition (NER) on input text data to identify entities such as “place names” and “event names”, and applies an object detection algorithm (e.g., YOLO or EfficientDet) to image data to identify main objects in the image and output their bounding box coordinates and class probabilities. The present analysis unit includes an inference server operating on a GPU cluster, and calculates a regional revitalization degree score or a tourism demand predicted value by a regression model using extracted feature vectors as input. The present cooperation unit connects to a core system of a local government via a secure API gateway and exchanges data by encrypted communication using mutual authentication (mTLS). The present provision unit is equipped with a dashboard generation engine for visualizing analysis results, and dynamically generates and distributes graph drawing data (SVG or Canvas instructions) optimized according to a terminal resolution or communication environment of a user. With these configurations, this system exhibits a technical effect of maximizing throughput and minimizing latency in processing large amounts and wide varieties of data.

The collection unit can collect data from a data source on the Internet. The collection unit can collect data from, for example, news sites, SNS, blogs, and the like. The collection unit can also collect data from, for example, Yahoo or messenger apps. The collection unit collects, for example, the latest news articles from news sites and stores them in a database. The collection unit collects, for example, posted contents of users from SNS and stores them in a database. The collection unit collects, for example, articles from blogs and stores them in a database. Thereby, the collection unit can acquire a wide range of information from data sources on the Internet. Part or all of the above-described processing in the collection unit may be performed using, for example, AI, or may be performed without using AI. For example, the collection unit can input data collected from a data source on the Internet into a generative AI and cause the generative AI to execute analysis of the data. Specifically, the present collection unit is equipped with a scraping module that receives a target URL list or search query as input and executes high-speed crawling using asynchronous I/O. The present collection unit inputs acquired unstructured text data such as HTML into a Large Language Model (LLM). Here, the input to the LLM is a token sequence including the body text and metadata of a Web page, and the output from the LLM is a structured JSON object including a summary of the article, main topics, sentiment polarity (positive/negative/neutral), and related entities (place names, organization names). The present collection unit uses this structured data to filter only useful information from noisy Web data, thereby reducing the subsequent processing load. Furthermore, the present collection unit implements a cyclic scheduler using reinforcement learning, observes the update frequency and importance of information of each Web site as a state, and determines the URL to be accessed next and the timing as an action, thereby maintaining the freshness of information while optimizing the utilization efficiency of network bandwidth.

The extraction unit can extract an element from the collected data. The extraction unit extracts elements such as keywords, feature quantities, and patterns from the collected data, for example. The extraction unit can extract keywords from text data using natural language processing technology, for example. The extraction unit can extract feature quantities from image data using image recognition technology, for example. The extraction unit can extract patterns from audio data using voice recognition technology, for example. Thereby, the extraction unit facilitates organization of data by extracting elements from the collected data. Part or all of the above-described processing in the extraction unit may be performed using, for example, AI, or may be performed without using AI. For example, the extraction unit can input collected data into a generative AI and cause the generative AI to execute extraction of elements. Specifically, the present extraction unit utilizes a multimodal deep learning model to perform mapping from heterogeneous data to a common semantic space. The present extraction unit uses a Transformer-based encoder (e.g., BERT) for text data to convert input sentences into fixed-length embedding vectors (e.g., 768 dimensions). The present extraction unit uses a convolutional neural network (e.g., ResNet) for image data to generate a visual feature map from an input image (e.g., 224×224 pixel RGB image) and pools it to obtain a feature vector. The present extraction unit uses a voice recognition model (e.g., Wav2Vec) for audio data to convert waveform data into a sequence of phonemes or words, and extracts a vector representing an emotion or prosodic features of a speaker. The present extraction unit gives these vectors as input to a generative AI (multimodal LLM), and obtains output of explanatory text such as “This image shows the state of XX festival and is lively” or tag information such as “festival”, “portable shrine”, and “summer” from the generative AI. Through this processing, the present extraction unit provides a technical effect of assigning semantic indexes to unstructured data and dramatically improving search accuracy and speed in a database.

The publication unit can publish the extracted data on the Internet. The publication unit publishes data using platforms such as websites, SNS, and databases, for example. The publication unit can, for example, post data on a website so that anyone can access it. The publication unit can, for example, post data on SNS and share it widely. The publication unit can, for example, store data in a database and make it searchable. Thereby, the publication unit promotes sharing of information by publishing the extracted data on the Internet. Part or all of the above-described processing in the publication unit may be performed using, for example, AI, or may be performed without using AI. For example, the publication unit can input extracted data into a generative AI and cause the generative AI to execute publication of the data. Specifically, the present publication unit is equipped with a content generation engine that takes extracted structured data and feature vectors as input and automatically generates content according to platform characteristics of a publication destination. The present publication unit inputs a prompt specifying extracted keywords, summary text, and a target reader layer (e.g., “for tourists”, “for researchers”) to the generative AI (LLM). In response to this, the generative AI outputs a title, body text, hashtags, and meta description of a blog article considering SEO (Search Engine Optimization). Also, the present publication unit uses an image generation AI to generate an eye-catching image matching the content of the article, or automatically performs processing such as blurring a person's face for privacy protection. The present publication unit automatically posts the generated content through an API of a CMS (Content Management System) and simultaneously updates a cache on a CDN (Content Delivery Network), thereby realizing information provision with low latency to users all over the world.

The cooperation unit can handle cooperation with a local government. The cooperation unit, for example, implements a joint project with a local government and collects and publishes data for disseminating the charm of the region. The cooperation unit can, for example, perform API cooperation with a local government to share data. The cooperation unit can, for example, hold an event jointly with a local government and collect and publish data of the event. The cooperation unit can, for example, cooperate with a local government to collect and publish data on traditional performing arts, customs, and legends of the region. Thereby, the cooperation unit creates a foundation for disseminating the charm of the region by handling cooperation with the local government. Part or all of the above-described processing in the cooperation unit may be performed using, for example, AI, or may be performed without using AI. For example, the cooperation unit can input data regarding cooperation with a local government into a generative AI and cause the generative AI to execute a proposal for a cooperation method. Specifically, the present cooperation unit is equipped with a data integration AI that converts heterogeneous formats of data (e.g., CSV, PDF, Excel, etc.) held by different local governments into a unified data schema. The present cooperation unit takes raw data provided by a local government as input, performs semantic analysis of the data using a generative AI, and outputs structured data such as a standardized JSON-LD format. Furthermore, the present cooperation unit vectorizes regional issues (e.g., “population decline”, “lack of tourists”) and held resources (“specialty products”, “natural scenery”) of each local government, and performs similarity calculation in a vector space, thereby causing the generative AI to plan matching between local governments where synergistic effects are expected or an optimal joint project plan (e.g., “mutual promotion of specialty products”). The input to the generative AI is attribute data of both local governments and a past success case database, and the output is a draft of a project plan, a predicted value of an expected economic effect, and a proposal for an implementation schedule. Thereby, the present cooperation unit brings about a technical effect of promoting data-driven and efficient inter-local government cooperation without depending on human resources.

The analysis unit allows AI to analyze the collected data. The analysis unit analyzes data using technologies such as machine learning, deep learning, and natural language processing, for example. The analysis unit can, for example, have the AI analyze the collected data and extract features of the data. The analysis unit can perform classification or clustering of data using a machine learning algorithm, for example. The analysis unit can recognize a pattern of data using a deep learning model, for example. The analysis unit can perform analysis of text data using natural language processing technology, for example. Thereby, the analysis unit enables efficient analysis of data by having the AI analyze the collected data. Part or all of the above-described processing in the analysis unit may be performed using, for example, a generative AI, or may be performed without using a generative AI. For example, the analysis unit can input collected data into a generative AI and cause the generative AI to execute analysis of the data. Specifically, the present analysis unit implements a prediction model and a classification model using a multi-layer neural network, and receives collected time-series data (e.g., transition of the number of tourists, number of mentions on SNS) as input. The present analysis unit uses a sequence transformation model such as LSTM (Long Short-Term Memory) or Transformer to predict future trends and demands, and outputs a predicted value (e.g., prediction of the number of visitors next month) and its confidence interval. Also, the present analysis unit uses an unsupervised learning algorithm (e.g., K-means or DBSCAN) to cluster collected regional data in a high-dimensional feature space, and automatically discovers regional groups having similar characteristics. Furthermore, the present analysis unit inputs analyzed numerical data and clustering results to a generative AI (LLM), and causes it to output a report describing insights implied by the results in natural language (e.g., text such as “Since interest among the younger generation is increasing in Region A as well as in Region B, SNS marketing is effective”). Through this processing, the present analysis unit provides interpretable information directly linked to decision-making, rather than a mere enumeration of numerical values.

The provision unit can provide an analysis result. The provision unit provides the analysis result in a format such as a report, a graph, or statistical data, for example. The provision unit can, for example, post the analysis result on a website so that anyone can access it. The provision unit can, for example, post the analysis result on SNS and share it widely. The provision unit can, for example, store the analysis result in a database and make it searchable. Thereby, the provision unit allows a user to utilize the analysis result by providing the analysis result. Part or all of the above-described processing in the provision unit may be performed using, for example, AI, or may be performed without using AI. For example, the provision unit can input an analysis result into a generative AI and cause the generative AI to execute provision of the result. Specifically, the present provision unit is equipped with a rendering engine that takes multidimensional analysis result data (tensor or vector) output by the analysis unit as input and determines an optimal visualization form according to attributes of a user or a viewing device. The present provision unit uses a generative AI to convert complex statistical data into a summary explanation in plain text. For example, structured data such as “Tourist number increase rate: 15%, Main factor: Festival event” is given as input, and the generative AI is caused to output natural language text such as “The number of tourists increased by 15% due to the influence of the festival”, which is displayed together with a graph. Also, the present provision unit executes a recommendation algorithm (e.g., collaborative filtering or matrix factorization) that dynamically changes the priority of information to be provided based on a past browsing history or an interest vector of a user. Thereby, the present provision unit exhibits a technical effect of pinpointing and presenting information that is truly valuable to the user from among a vast amount of analysis results, and reducing cognitive load due to information overload.

The collection unit can analyze an emotion of a user and adjust a timing of data collection based on the analyzed emotion of the user. The collection unit performs data collection immediately, for example, when the user is relaxed. The collection unit postpones data collection, for example, when the user is busy. The collection unit suspends data collection, for example, when the user is excited. Thereby, the collection unit can collect data at a more appropriate timing by adjusting the timing of data collection according to the emotion of the user. Estimation of the emotion is realized using an emotion estimation function using, for example, an emotion engine or a generative AI. The generative AI is, for example, a text generative AI (e.g., LLM) or a multimodal generative AI, but is not limited to such examples. Part or all of the above-described processing in the collection unit may be performed using, for example, AI, or may be performed without using AI. For example, the collection unit can input emotion data of a user into a generative AI and cause the generative AI to execute adjustment of the timing of data collection. Specifically, the present collection unit is equipped with a multimodal emotion recognition model that takes biological data (facial expression image, voice waveform, heart rate variability data, etc.) acquired from a camera, a microphone, or a wearable sensor of a user terminal as input. This model has an architecture combining a Convolutional Neural Network (CNN) and a Recurrent Neural Network (RNN), and outputs a probability vector representing an emotional state (e.g., [Joy: 0.1, Anger: 0.0, Relax: 0.8, Impatience: 0.1]) from input data. The present collection unit executes logic to compare this output emotion score with a predetermined threshold, and generates a control signal to trigger a data collection request (questionnaire display or location information transmission request) only when, for example, the “Relax” score exceeds the threshold. Conversely, when the score of “Impatience” or “Anger” is high, back-off control is performed to suppress interrupt processing, thereby preventing deterioration of User Experience (UX). With this emotion-adaptive scheduling, the present system maximizes the collection rate of high-quality data while minimizing the psychological burden on the user.

The collection unit can analyze a past data provision history of a user and select an appropriate collection method. The collection unit preferentially collects similar data, for example, based on a type of data provided by the user in the past. The collection unit adjusts a collection frequency, for example, based on an amount of data provided by the user in the past. The collection unit optimizes a collection method, for example, based on a quality of data provided by the user in the past. Thereby, the collection unit can select an optimal collection method by analyzing the past data provision history of the user. Part or all of the above-described processing in the collection unit may be performed using, for example, AI, or may be performed without using AI. For example, the collection unit can input a past data provision history of a user into a generative AI and cause the generative AI to execute selection of a collection method. Specifically, the present collection unit accumulates interaction logs (provision date and time, data type, response time, provided data amount) of each user in a database as time-series data, and uses this as input to train a reinforcement learning model (e.g., DQN or PPO). In this model, a state (State) is defined as a user's history feature vector, an action (Action) is defined as selection of a collection method (push notification, email, in-app popup, etc.), and a reward (Reward) is defined as success or failure of data acquisition or a data quality score. The present collection unit uses the learned model to infer and execute a collection action that maximizes an expected reward for a current user state. Also, when using a generative AI, the present collection unit embeds a user's behavior log in a text format into a prompt (e.g., “This user tends to provide many photo data on weekend nights”), and causes the generative AI to output an optimal collection plan (date and time, request text, incentive). This realizes adaptive data collection control personalized to individual user characteristics, which is impossible with uniform rule-based control.

The collection unit can perform filtering based on a current field of interest of a user at a time of data collection. The collection unit preferentially collects data related to a topic in which the user is currently interested, for example. The collection unit filters data based on keywords recently searched by the user, for example. The collection unit collects data based on a topic of an online community in which the user participates, for example. Thereby, the collection unit can collect highly relevant data by filtering data based on the current field of interest of the user. Part or all of the above-described processing in the collection unit may be performed using, for example, AI, or may be performed without using AI. For example, the collection unit can input data regarding a field of interest of a user into a generative AI and cause the generative AI to execute filtering of data. Specifically, the present collection unit analyzes activity data such as a search history, a browsing history, and “likes” on SNS of a user in real time, and generates a user profile vector representing the interest of the user. At the same time, a content vector is generated using a natural language processing model (e.g., BERT or Sentence-BERT) for data to be collected (Web article, image, etc.). The present collection unit calculates a cosine similarity between the user profile vector and the content vector in a high-dimensional vector space, and executes filtering processing to selectively collect and store only data whose similarity exceeds a predetermined threshold. When using a generative AI, the present collection unit takes a list of interest keywords of a user and a summary of collection candidate data as input, requests the generative AI to output a binary classification judgment of “relevant/not relevant” or a relevance score from 0 to 1, and selects data based on the result. This vector-based matching processing enables high-precision filtering considering semantic relevance, realizing saving of storage capacity and improvement of information density.

The collection unit can analyze an emotion of a user and determine a priority of data to be collected based on the analyzed emotion of the user. The collection unit preferentially collects data with high importance, for example, when the user is relaxed. The collection unit postpones data with low importance, for example, when the user is busy. The collection unit preferentially collects data related to emotion, for example, when the user is excited. Thereby, the collection unit can preferentially collect important data by determining the priority of data to be collected according to the emotion of the user. Estimation of the emotion is realized using an emotion estimation function using, for example, an emotion engine or a generative AI. The generative AI is, for example, a text generative AI (e.g., LLM) or a multimodal generative AI, but is not limited to such examples. Part or all of the above-described processing in the collection unit may be performed using, for example, AI, or may be performed without using AI. For example, the collection unit can input emotion data of a user into a generative AI and cause the generative AI to execute determination of a priority of data. Specifically, the present collection unit is equipped with a priority queue (Priority Queue) that manages collection tasks, and has a scoring engine that dynamically calculates a priority score of each task. This scoring engine receives, as input, an original importance of data (static score) and a current emotion vector of the user (dynamic coefficient) output from an emotion recognition model. For example, when the user is in a “relax” state (high coefficient), the engine amplifies the score of a task with high importance and places it at the head of the queue. On the other hand, when the user is in a “stress” state (low coefficient), the score of a high-load task is attenuated, and a low-load task or a highly entertaining data collection task is prioritized. When using a generative AI, the present collection unit inputs an emotion state and a task list, causes the generative AI to output an optimal execution order list, and controls a task scheduler according to the order. This makes it possible to collect important data at a moment when the user's psychological receptivity is high, improving the completion rate and quality of data collection.

The collection unit can preferentially collect highly relevant data in consideration of geographical location information of a user at a time of data collection. The collection unit preferentially collects data related to a region where the user is currently located, for example. The collection unit collects data related to a place visited by the user in the past, for example. The collection unit collects data related to a place scheduled to be visited by the user in the future, for example. Thereby, the collection unit can preferentially collect highly relevant data by considering the geographical location information of the user. Part or all of the above-described processing in the collection unit may be performed using, for example, AI, or may be performed without using AI. For example, the collection unit can input geographical location information of a user into a generative AI and cause the generative AI to execute collection of data. Specifically, the present collection unit takes latitude and longitude information and movement history data of a user acquired from GPS, a Wi-Fi access point, or a beacon as input. The present collection unit uses a geospatial index (e.g., R-Tree or Quadtree) to search for data sources (store information, tourist spots, regional news) existing around the current position of the user (within a geofence) at high speed. Furthermore, the present collection unit analyzes a movement trajectory of the user using a sequence prediction model such as a Recurrent Neural Network (RNN) to predict a destination likely to be visited next. The present collection unit inputs the current location and position information of the predicted destination as a query into a generative AI or a search engine, and preferentially crawls and caches culture, events, traffic information, etc., specific to that region. This creates a state where necessary data is already prepared locally at the time the user arrives at that place, providing a zero-latency experience that improves responsiveness of an application.

The collection unit can analyze social media activity of a user and collect related data at a time of data collection. The collection unit collects data related to contents recently posted by the user, for example. The collection unit collects data based on posted contents of an account followed by the user, for example. The collection unit collects data related to a topic of a group in which the user participates, for example. Thereby, the collection unit can collect related data by analyzing the social media activity of the user. Part or all of the above-described processing in the collection unit may be performed using, for example, AI, or may be performed without using AI. For example, the collection unit can input data regarding social media activity of a user into a generative AI and cause the generative AI to execute collection of data. Specifically, the present collection unit models a social graph of a user using a Graph Neural Network (GNN), and expresses relationships between the user and other accounts, topics, and communities as embedding vectors. The present collection unit extracts feature quantities not only from posted text of the user himself/herself but also from posts of influencers followed by the user or images “liked” by the user, and identifies a potential interest cluster of the user. When using a generative AI, the present collection unit inputs a recent SNS activity log (posted text, hashtags, reactions) of the user as a prompt, causes the generative AI to infer “a topic in which this user is likely to be interested next” or “keywords of related news to be collected”, and controls a Web crawler using the output keywords. This makes it possible to collect information matching potential needs of the user in advance before an explicit search action is performed.

The extraction unit can analyze an emotion of a user and determine a priority of an element to be extracted based on the analyzed emotion of the user. The extraction unit preferentially extracts an element with high importance, for example, when the user is relaxed. The extraction unit postpones an element with low importance, for example, when the user is busy. The extraction unit preferentially extracts an element related to emotion, for example, when the user is excited. Thereby, the extraction unit can preferentially extract an important element by determining the priority of an element to be extracted according to the emotion of the user. Estimation of the emotion is realized using an emotion estimation function using, for example, an emotion engine or a generative AI. The generative AI is, for example, a text generative AI (e.g., LLM) or a multimodal generative AI, but is not limited to such examples. Part or all of the above-described processing in the extraction unit may be performed using, for example, AI, or may be performed without using AI. For example, the extraction unit can input emotion data of a user into a generative AI and cause the generative AI to execute extraction of an element. Specifically, the present extraction unit manages a task list defining a processing cost and importance for each feature quantity (entity, image object, audio keyword, etc.) to be extracted in a data processing pipeline. The present extraction unit takes an emotion state of the user (e.g., Arousal and Valence) output from an emotion recognition model as input, and executes a dynamic weighting algorithm. For example, when it is determined that the user has high arousal and demands immediacy, the present extraction unit raises the priority of “keyword extraction” with low calculation cost and lowers the priority of “deep semantic analysis” with high calculation cost. When using a generative AI, the present extraction unit gives input data (text or image) and a user emotion label as a prompt, causes the generative AI to identify “an element that most resonates with the current user emotion (e.g., positive words or vivid color information when in a happy mood)”, and selectively extracts and outputs only that element. This optimally allocates limited calculation resources according to the current psychological state of the user, improving responsiveness of the entire system and user satisfaction.

The extraction unit can adjust a degree of detail of extraction based on an importance of data at a time of extraction. The extraction unit extracts data with high importance in detail, for example. The extraction unit extracts data with low importance simply, for example. The extraction unit adjusts the degree of detail of extraction stepwise according to importance, for example. Thereby, the extraction unit enables efficient extraction by adjusting the degree of detail of extraction based on the importance of data. Part or all of the above-described processing in the extraction unit may be performed using, for example, AI, or may be performed without using AI. For example, the extraction unit can input an importance of data into a generative AI and cause the generative AI to execute adjustment of the degree of detail of extraction. Specifically, the present extraction unit is equipped with a scoring model that calculates an importance score (0.0 to 1.0) of data based on metadata (reliability of source, number of accesses, update date and time) of input data or a summary of contents. The present extraction unit has an adaptive processing mechanism that switches the complexity of an extraction model to be applied according to this score. For example, when the importance score is high (equal to or greater than a threshold), the present extraction unit uses a large-scale model (e.g., GPT-4 class LLM or high-resolution image analysis model) that is highly accurate but has a high calculation load to extract even minute nuances or small objects in detail. On the other hand, when the importance score is low, the present extraction unit uses a lightweight model (e.g., DistilBERT or MobileNet) to extract only main keywords or rough categories. When using a generative AI, the present extraction unit dynamically changes an instruction such as “analyze in detail” or “summarize briefly” in a prompt according to importance, and controls the number of output tokens from the generative AI. This processing allows calculation costs commensurate with the value of information to be invested, optimizing throughput and cost efficiency of the entire system.

The extraction unit can apply a different extraction algorithm according to a category of data at a time of extraction. The extraction unit applies an image recognition algorithm to image data, for example. The extraction unit applies a voice recognition algorithm to audio data, for example. The extraction unit applies a video analysis algorithm to video data, for example. Thereby, the extraction unit enables appropriate extraction by applying a different extraction algorithm according to the category of data. Part or all of the above-described processing in the extraction unit may be performed using, for example, AI, or may be performed without using AI. For example, the extraction unit can input a category of data into a generative AI and cause the generative AI to execute application of an extraction algorithm. Specifically, the present extraction unit is equipped with a dispatcher that analyzes a MIME type or a binary header of input data to determine a data type (text, image, audio, video). In the case of image data, the present extraction unit loads an object detection/segmentation model using a Convolutional Neural Network (CNN) or Vision Transformer (ViT), and outputs an object region and a class label from pixel data. In the case of audio data, the present extraction unit uses an Automatic Speech Recognition (ASR) model (e.g., Whisper) to convert a voice waveform into text and further extracts acoustic feature quantities (pitch, tone). In the case of text data, the present extraction unit uses a Transformer-based language model to perform syntax analysis or semantic role labeling. When using a generative AI, the present extraction unit passes input data to a single huge model supporting multimodal input, and instructs it with a prompt such as “list objects in the image” or “summarize the content of the audio”, thereby causing it to execute a task according to the data format. This automatically applies a dedicated optimized processing pipeline to various formats of data, realizing high-precision information extraction.

The extraction unit can analyze an emotion of a user and adjust a display method of an element to be extracted based on the analyzed emotion of the user. The extraction unit provides a detailed display method, for example, when the user is relaxed. The extraction unit provides a concise display method, for example, when the user is busy. The extraction unit provides a visually stimulating display method, for example, when the user is excited. Thereby, the extraction unit enables appropriate display by adjusting the display method of an element to be extracted according to the emotion of the user. Estimation of the emotion is realized using an emotion estimation function using, for example, an emotion engine or a generative AI. The generative AI is, for example, a text generative AI (e.g., LLM) or a multimodal generative AI, but is not limited to such examples. Part or all of the above-described processing in the extraction unit may be performed using, for example, AI, or may be performed without using AI. For example, the extraction unit can input emotion data of a user into a generative AI and cause the generative AI to execute adjustment of a display method. Specifically, the present extraction unit has a function of assigning metadata for UI display (font size, color, layout type, summary level) to extracted data elements (text, image, numerical value). The present extraction unit takes a user's emotion vector (e.g., [Relaxation level, Arousal level]) obtained from an emotion recognition model as input, and executes rule-based or learning-based logic to determine values of these metadata. For example, when it is determined that the user is “busy (high arousal level, low relaxation level)”, the present extraction unit summarizes text data to the limit and sets a flag for display in a bulleted list format. On the other hand, when the user is “relaxed”, metadata for displaying detailed explanatory text or a high-resolution image is assigned. When using a generative AI, the present extraction unit takes extracted raw data and user emotion as input, gives an instruction such as “Generate a narrative commentary because the user is relaxed” to the generative AI, and causes it to convert and output the content itself for display according to the emotion. This enables information presentation matching the psychological state of the user, having an effect of increasing receptivity and understanding of information.

The extraction unit can determine a priority of extraction based on a submission time of data at a time of extraction. The extraction unit preferentially extracts recently submitted data, for example. The extraction unit postpones old data, for example. The extraction unit adjusts the priority of extraction stepwise according to the submission time, for example. Thereby, the extraction unit enables efficient extraction by determining the priority of extraction based on the submission time of data. Part or all of the above-described processing in the extraction unit may be performed using, for example, AI, or may be performed without using AI. For example, the extraction unit can input a submission time of data into a generative AI and cause the generative AI to execute determination of a priority of extraction. Specifically, the present extraction unit is equipped with a scheduler that manages a data processing queue (queue), and refers to timestamp information of each data packet. The present extraction unit calculates a difference (elapsed time) between the current time and the timestamp of data, and uses a decay function (Decay Function) that assigns a higher priority score to data with a shorter elapsed time (newer). For example, an exponential decay model is used to maintain a high score for recent data requiring real-time performance, and data for which a certain period has elapsed is moved to a low-priority queue for batch processing. When using a generative AI, the present extraction unit takes metadata (creation date and time, expiration date) of data as input, causes the generative AI to judge “Is this data urgent?”, and dynamically rearranges the processing order based on the judgment result (High/Medium/Low). This exhibits a technical effect of processing data requiring immediacy such as news and disaster information without delay and guaranteeing freshness of information.

The extraction unit can adjust an order of extraction based on relevance of data at a time of extraction. For example, the extraction unit preferentially extracts highly relevant data. For example, the extraction unit postpones data with low relevance. For example, the extraction unit adjusts the order of extraction in stages according to the relevance. Accordingly, the extraction unit can perform efficient extraction by adjusting the order of extraction based on the relevance of data. Part or all of the above-described processing in the extraction unit may be performed using, for example, AI, or may be performed without using AI. For example, the extraction unit can input the relevance of data into generative AI and cause the generative AI to execute the adjustment of the order of extraction. Specifically, the present extraction unit vectorizes a currently processed task or a context focused on by a user, and performs similarity calculation with vectors of a waiting data group. The present extraction unit calculates an inner product or cosine similarity between a context vector and a data vector, determines data with high similarity as being “highly relevant,” and moves the data to the head of a processing queue. For example, if data regarding a “festival” in a certain region is being processed, the priority of data regarding “traffic information” or “weather” in the same region is dynamically raised. When using generative AI, the present extraction unit inputs the current context and a data list, causes the generative AI to infer “which data is the most highly relevant data to be processed next,” and controls a processing flow based on the output. This enables consistent information extraction in line with the context, eliminating inefficiency caused by fragmented data processing.

The publication unit can analyze an emotion of a user and adjust a display method of data to be published based on the analyzed emotion of the user. For example, when the user is relaxed, the publication unit provides a detailed display method. For example, when the user is busy, the publication unit provides a concise display method. For example, when the user is excited, the publication unit provides a visually stimulating display method. Accordingly, the publication unit can perform appropriate display by adjusting the display method of data to be published according to the emotion of the user. Estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the publication unit may be performed using, for example, AI, or may be performed without using AI. For example, the publication unit can input emotion data of the user into generative AI and cause the generative AI to execute the adjustment of the display method. Specifically, the present publication unit includes a rendering engine configured to dynamically generate HTML/CSS or UI components constituting a Web page or an application screen. The present publication unit receives, as input, emotion parameters (e.g., stress level, concentration level) of the user received from an emotion recognition module, and changes CSS variables (font size, line spacing, color scheme theme) or DOM structure (number and order of sections to be displayed). For example, when the user is in an “excited” state, a dynamic layout using a high-saturation color scheme and large images is generated, and when the user is in a “relaxed” state, a static layout using pastel colors and an easy-to-read Mincho font is generated. When using generative AI, the present publication unit inputs original data and the user emotion, instructs the generative AI to “create a catchy headline and an impactful summary for an excited user,” and displays the generated text in combination with style information. This has an effect of providing an interface synchronized with the psychological state of the user and increasing engagement.

The publication unit can adjust a degree of detail of publication based on an importance of data at a time of publication. For example, the publication unit publishes highly important data in detail. For example, the publication unit publishes data with low importance simply. For example, the publication unit adjusts the degree of detail of publication in stages according to the importance. Accordingly, the publication unit can perform efficient publication by adjusting the degree of detail of publication based on the importance of data. Part or all of the above-described processing in the publication unit may be performed using, for example, AI, or may be performed without using AI. For example, the publication unit can input the importance of data into generative AI and cause the generative AI to execute the adjustment of the degree of detail of publication. Specifically, the present publication unit has filtering logic configured to control a level of information disclosure (Level of Detail: LOD) according to an importance score of data (a value based on access frequency prediction or social impact). For highly important data (e.g., disaster warnings, major tourism events), the present publication unit publishes a full set of information including full text, high-resolution images, and related links. On the other hand, for data with low importance (e.g., routine logs, minor update information), only a title and a one-line summary are displayed, and details are hidden behind a “see more” button, or publication itself is omitted. When using generative AI, the present publication unit inputs original data and the importance score, gives a prompt such as “generate a detailed explanatory article because the importance is high” or “summarize in 30 characters because the importance is low” to the generative AI, and adopts the output text as content for publication. This produces a technical effect of concentrating the user's attentional resources on important information and preventing information overload.

The publication unit can apply a different publication algorithm according to a category of data at a time of publication. For example, the publication unit applies an image display algorithm to image data. For example, the publication unit applies an audio playback algorithm to audio data. For example, the publication unit applies a video playback algorithm to video data. Accordingly, the publication unit can perform appropriate publication by applying a different publication algorithm according to the category of data. Part or all of the above-described processing in the publication unit may be performed using, for example, AI, or may be performed without using AI. For example, the publication unit can input the category of data into generative AI and cause the generative AI to execute the application of the publication algorithm. Specifically, the present publication unit includes a selector function configured to analyze a MIME type or metadata of content and select an optimal playback player or viewer component. In the case of image data, the present publication unit performs lazy loading or automatic conversion to a high-compression format such as WebP, and applies an algorithm for displaying in a slideshow format or a grid format. In the case of video data, the present publication unit uses adaptive streaming (HLS or DASH) technology that automatically adjusts a bit rate according to a bandwidth of the user, and controls preview playback or automatic playback. When using generative AI, the present publication unit inputs the category and content of data, instructs the generative AI to “generate HTML/JavaScript code for showing this data most effectively,” causes the generative AI to output, for example, interactive viewer code using WebGL if the data is 3D model data, and embeds the code in a page. This automatically constructs a display environment that always provides an optimal user experience (UX) for a wide variety of media formats.

The publication unit can analyze an emotion of a user and determine a priority of data to be published based on the analyzed emotion of the user. For example, when the user is relaxed, the publication unit preferentially publishes highly important data. For example, when the user is busy, the publication unit postpones data with low importance. For example, when the user is excited, the publication unit preferentially publishes data related to the emotion. Accordingly, the publication unit can preferentially publish important data by determining the priority of data to be published according to the emotion of the user. Estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the publication unit may be performed using, for example, AI, or may be performed without using AI. For example, the publication unit can input emotion data of the user into generative AI and cause the generative AI to execute the determination of the priority of data. Specifically, the present publication unit incorporates the emotion state of the user as a feature quantity into a ranking algorithm (Learning to Rank) that determines a display order of a news feed or a timeline. When calculating a score of each content, if the user is in a “relaxed” state, the present publication unit increases a weight of long reading material or deep analysis articles (high importance) and displays them at the top. Conversely, if the user is in a “busy (feeling impatient)” state, the present publication unit increases a weight of snack content that can be consumed in a short time or data describing only a conclusion. When using generative AI, the present publication unit inputs a candidate content list and an emotion vector of the user, instructs the generative AI to “reorder in an order optimal for the current mood of the user,” and obtains a re-ranked list as output. This enables information provision tailored to the user's receptivity, maximizing content click-through rate (CTR) and dwell time.

The publication unit can determine a priority of publication based on a submission time of data at a time of publication. For example, the publication unit preferentially publishes recently submitted data. For example, the publication unit postpones old data. For example, the publication unit adjusts the priority of publication in stages according to the submission time. Accordingly, the publication unit can perform efficient publication by determining the priority of publication based on the submission time of data. Part or all of the above-described processing in the publication unit may be performed using, for example, AI, or may be performed without using AI. For example, the publication unit can input the submission time of data into generative AI and cause the generative AI to execute the determination of the priority of publication. Specifically, the present publication unit cooperates with a real-time stream processing infrastructure (e.g., Apache Flink or Spark Streaming) to manage data generation time (Event Time) and system arrival time (Processing Time). The present publication unit sets a time window and push-delivers data included in the latest window to a user interface with the highest priority (using WebSocket or the like). Old data is moved to archive storage and switched to pull-type delivery that displays the data only when a search query is issued. When using generative AI, the present publication unit inputs timestamps and contents of a plurality of data, causes the generative AI to determine “what is the hottest topic to be displayed now in consideration of chronological context,” and dynamically replaces content of a top news frame based on the determination. This produces a technical effect of always conveying the latest situation to the user in use cases such as news sites or stock price information where freshness of information is prioritized.

The publication unit can adjust an order of publication based on relevance of data at a time of publication. For example, the publication unit preferentially publishes highly relevant data. For example, the publication unit postpones data with low relevance. For example, the publication unit adjusts the order of publication in stages according to the relevance. Accordingly, the publication unit can perform efficient publication by adjusting the order of publication based on the relevance of data. Part or all of the above-described processing in the publication unit may be performed using, for example, AI, or may be performed without using AI. For example, the publication unit can input the relevance of data into generative AI and cause the generative AI to execute the adjustment of the order of publication. Specifically, the present publication unit is equipped with a hybrid recommendation engine combining collaborative filtering and content-based filtering. The present publication unit calculates similarity (cosine similarity, etc.) between a feature vector of content currently being viewed by the user and feature vectors of other content in a database, and lists them as “related articles” or “recommendations” in descending order of similarity. Furthermore, the present publication unit inputs a user's behavior history (click transitions) within a session into an RNN (Recurrent Neural Network), predicts a category of information the user will want next, and raises a display rank of data belonging to that category. When using generative AI, the present publication unit inputs an article being viewed and a list of candidate articles, causes the generative AI to infer “choose an article that a person who read this article would want to read next,” and dynamically generates navigation links based on the result. This prevents the user's interest from being interrupted and improves the circulation rate within the site.

The cooperation unit can analyze an emotion of a local government and adjust a method of cooperation based on the analyzed emotion. For example, when the local government is relaxed, the cooperation unit proposes a detailed cooperation method. For example, when the local government is busy, the cooperation unit proposes a concise cooperation method. For example, when the local government is excited, the cooperation unit proposes an active cooperation method. Accordingly, the cooperation unit can perform appropriate cooperation by adjusting the method of cooperation according to the emotion of the local government. Estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the cooperation unit may be performed using, for example, AI, or may be performed without using AI. For example, the cooperation unit can input emotion data of the local government into generative AI and cause the generative AI to execute the adjustment of the cooperation method. Specifically, the present cooperation unit receives, as input, voice data of emails, chats, or online meetings with a person in charge at the local government, and performs sentiment analysis by natural language processing (NLP) or voice emotion analysis. The present cooperation unit estimates an organizational “emotion state (atmosphere)” of the other party from emotion words such as “gratitude,” “dissatisfaction,” and “impatience” in text, or pitch and speed of voice. For example, if it is determined that they are “busy (impatient)” at the end of the fiscal year, the present cooperation unit automatically sends a “quick start guide” which is a simplified version of an API cooperation procedure manual, or proposes a script for automating procedures. Conversely, if it is determined that they are “relaxed (having room),” the present cooperation unit generates and sends a proposal for long-term joint research or a large-scale data integration project. When using generative AI, the present cooperation unit inputs the emotion state of the other party and proposal content, causes the generative AI to create a “polite and effective proposal email considering the situation of the other party,” and sends the email. This realizes smooth communication and increases a closing rate and a success rate of cooperation projects.

The cooperation unit can refer to a past cooperation history of the local government and select an appropriate cooperation method at a time of cooperation. For example, the cooperation unit proposes an optimal cooperation method based on a cooperation method with which the local government has succeeded in the past. For example, the cooperation unit avoids a cooperation method with which the local government has failed in the past. For example, the cooperation unit analyzes the past cooperation history of the local government and selects an optimal cooperation method. Accordingly, the cooperation unit can select an optimal cooperation method by referring to the past cooperation history of the local government. Part or all of the above-described processing in the cooperation unit may be performed using, for example, AI, or may be performed without using AI. For example, the cooperation unit can input the past cooperation history of the local government into generative AI and cause the generative AI to execute the selection of the cooperation method. Specifically, the present cooperation unit structures data of all past cooperation projects (implementation details, period, budget, performance indicator KPI, evaluation by person in charge) and accumulates the data in a database (case base). The present cooperation unit uses a Case-Based Reasoning (CBR) algorithm or similarity search to search for success cases of local governments having characteristics (population scale, industrial structure, past history) similar to those of a current candidate local government for cooperation. The present cooperation unit adopts the searched success case (best practice) as a template and formulates a cooperation plan customized for the current local government. When using generative AI, the present cooperation unit inputs history data of a target local government and a list of success/failure cases, and causes the generative AI to formulate a “plan incorporating a success pattern (e.g., linkage with a tourism event) while avoiding a past failure pattern (e.g., interruption due to budget shortage).” This enables data-driven decision making that does not rely on rules of thumb, minimizing risks of cooperation and maximizing effects.

The cooperation unit can analyze an emotion of the local government and determine a priority of cooperation based on the analyzed emotion. For example, when the local government is relaxed, the cooperation unit prioritizes highly important cooperation. For example, when the local government is busy, the cooperation unit postpones cooperation with low importance. For example, when the local government is excited, the cooperation unit prioritizes cooperation related to the emotion. Accordingly, the cooperation unit can preferentially perform important cooperation by determining the priority of cooperation according to the emotion of the local government. Estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the cooperation unit may be performed using, for example, AI, or may be performed without using AI. For example, the cooperation unit can input emotion data of the local government into generative AI and cause the generative AI to execute the determination of the priority of cooperation. Specifically, the present cooperation unit has a scoring engine configured to cooperate with a CRM (Customer Relationship Management) system and dynamically manage priorities of tasks and projects with each local government. The present cooperation unit calculates “urgency” and “importance” of each cooperation matter using, as input variables, content and frequency of inquiries from the local government and an emotion score (sentiment analysis result) of a person in charge. For example, if the other party shows “excitement (positive enthusiasm),” the priority of a related project is raised to the highest level and resources (personnel and computer resources) are concentrated so as not to miss the momentum. Conversely, if the other party shows “confusion” or “anger,” the priority of a new proposal is lowered, and the priority of support or a problem-solving task is raised instead. When using generative AI, the present cooperation unit inputs statuses of all matters and emotion data, causes the generative AI to create a “ranking of local governments to be approached this week,” and optimizes sales activities and support activities.

The cooperation unit can select an optimal cooperation method in consideration of geographical location information of the local government at a time of cooperation. For example, the cooperation unit proposes an optimal cooperation method based on the geographical location of the local government. For example, the cooperation unit adjusts the cooperation method in consideration of geographical characteristics of the local government. For example, the cooperation unit selects an optimal cooperation method based on the geographical location information of the local government. Accordingly, the cooperation unit can select an optimal cooperation method by considering the geographical location information of the local government. Part or all of the above-described processing in the cooperation unit may be performed using, for example, AI, or may be performed without using AI. For example, the cooperation unit can input the geographical location information of the local government into generative AI and cause the generative AI to execute the selection of the cooperation method. Specifically, the present cooperation unit utilizes GIS (Geographic Information System) data to vectorize and manage location information (latitude and longitude), terrain data, transportation networks, climate zones, etc. of each local government. The present cooperation unit uses a spatial clustering algorithm (e.g., DBSCAN) to identify a group of local governments that are geographically close and share common issues (e.g., a group of local governments in heavy snowfall areas, a group of tourism local governments in coastal areas). The present cooperation unit proposes a wide-area cooperation project (e.g., data sharing of wide-area sightseeing routes, a mutual accommodation system for snow removal resources) to these groups. When using generative AI, the present cooperation unit inputs location information of a target local government and data of surrounding local governments, causes the generative AI to output “ideas for creating synergistic effects by cooperating with neighboring local governments,” and causes the generative AI to formulate specific measures such as “developing a common stamp rally app in adjacent City A and Town B.” This realizes effective regional cooperation that takes advantage of geographical constraints and characteristics.

The analysis unit can analyze an emotion of a user and adjust a method of analysis based on the analyzed emotion of the user. For example, when the user is relaxed, the analysis unit performs detailed analysis. For example, when the user is busy, the analysis unit performs simple analysis. For example, when the user is excited, the analysis unit performs analysis related to the emotion. Accordingly, the analysis unit can perform appropriate analysis by adjusting the method of analysis according to the emotion of the user. Estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the analysis unit may be performed using, for example, AI, or may be performed without using AI. For example, the analysis unit can input emotion data of the user into generative AI and cause the generative AI to execute the adjustment of the analysis method. Specifically, the present analysis unit includes an orchestrator configured to dynamically change a configuration of a data analysis pipeline. The present analysis unit receives an emotion state of the user (e.g., curious, in a hurry) as an input parameter, and selects an analysis module to be executed. When the user is “relaxed (curious),” the present analysis unit fully operates not only basic statistics but also detailed analysis modules with high computational load such as correlation analysis, causal inference, and time series prediction, and derives multifaceted insights. On the other hand, when the user is “busy,” the present analysis unit selects a lightweight analysis path that only calculates major KPIs (Key Performance Indicators) and returns a result immediately. When using generative AI, the present analysis unit inputs a data set and the user emotion, causes the generative AI to propose an “angle of in-depth analysis in which the user is likely to be interested,” and automatically generates and executes an SQL query or Python code along the angle (e.g., trend analysis by age). This provides analysis results with depth and speed that match the psychological needs of the user.

The analysis unit can adjust a degree of detail of analysis based on an importance of data at a time of analysis. For example, the analysis unit analyzes highly important data in detail. For example, the analysis unit analyzes data with low importance simply. For example, the analysis unit adjusts the degree of detail of analysis in stages according to the importance. Accordingly, the analysis unit can perform efficient analysis by adjusting the degree of detail of analysis based on the importance of data. Part or all of the above-described processing in the analysis unit may be performed using, for example, AI, or may be performed without using AI. For example, the analysis unit can input the importance of data into generative AI and cause the generative AI to execute the adjustment of the degree of detail of analysis. Specifically, the present analysis unit calculates an importance score based on metadata of input data or a preliminary scan result. For highly important data (e.g., data containing outliers, core data related to management decisions), the present analysis unit applies a high-precision model using deep learning (e.g., a Transformer-based time series prediction model) or a computationally intensive algorithm such as Monte Carlo simulation to obtain an analysis result with few errors. For data with low importance, a lightweight algorithm such as linear regression or moving average is applied to save calculation resources (GPU/CPU time). When using generative AI, the present analysis unit inputs an outline and importance of data, causes the generative AI to determine “what is the optimal statistical method to be applied to this data,” and calls a function of an analysis library (Pandas, Scikit-learn, etc.) based on the determination. This optimally allocates limited calculation resources and maximizes cost performance of the entire system.

The analysis unit can apply a different analysis algorithm according to a category of data at a time of analysis. For example, the analysis unit applies an image analysis algorithm to image data. For example, the analysis unit applies an audio analysis algorithm to audio data. For example, the analysis unit applies a video analysis algorithm to video data. Accordingly, the analysis unit can perform appropriate analysis by applying a different analysis algorithm according to the category of data. Part or all of the above-described processing in the analysis unit may be performed using, for example, AI, or may be performed without using AI. For example, the analysis unit can input the category of data into generative AI and cause the generative AI to execute the application of the analysis algorithm. Specifically, the present analysis unit manages a model repository (Model Zoo) and dynamically loads an optimal trained model according to a modality of data (image, text, audio, tabular data). In the case of image data, the present analysis unit performs feature extraction or object recognition using a CNN (e.g., ResNet). In the case of text data, the present analysis unit performs sentiment analysis or summarization using an LLM such as BERT or GPT. In the case of time series numerical data, the present analysis unit performs trend prediction using ARIMA or LSTM. When using generative AI, the present analysis unit adopts an AutoML (Automated Machine Learning)-like approach, inputs a data sample and category information into the generative AI, causes the generative AI to generate “Python code (using PyTorch or TensorFlow) for analyzing this data,” and executes the code in a sandbox environment, thereby performing analysis flexibly corresponding even to an unknown data format. This enables integrated analysis of a wide variety of data on a single platform.

The analysis unit can analyze an emotion of a user and determine a priority of analysis based on the analyzed emotion of the user. For example, when the user is relaxed, the analysis unit prioritizes highly important analysis. For example, when the user is busy, the analysis unit postpones analysis with low importance. For example, when the user is excited, the analysis unit prioritizes analysis related to the emotion. Accordingly, the analysis unit can preferentially perform important analysis by determining the priority of analysis according to the emotion of the user. Estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the analysis unit may be performed using, for example, AI, or may be performed without using AI. For example, the analysis unit can input emotion data of the user into generative AI and cause the generative AI to execute the determination of the priority of analysis. Specifically, the present analysis unit cooperates with a job scheduler configured to manage analysis jobs, and dynamically controls execution priority of each job. The present analysis unit monitors the emotion state of the user (e.g., impatience, expectation) in real time, and if the user is in a hurry for a result (impatience), sets the priority of an analysis job requested by the user to the highest level, and pauses other background jobs to allocate resources (preemption control). On the other hand, if the user is in a state where they can relax and wait, adjustment such as shifting the job to night batch processing is performed. When using generative AI, the present analysis unit inputs a waiting job list and the user emotion, causes the generative AI to formulate a “job execution schedule that maximizes user satisfaction,” and executes processing according to the schedule. This achieves both leveling of system resources and improvement of user experience.

The analysis unit can determine a priority of analysis based on a submission time of data at a time of analysis. For example, the analysis unit preferentially analyzes recently submitted data. For example, the analysis unit postpones old data. For example, the analysis unit adjusts the priority of analysis in stages according to the submission time. Accordingly, the analysis unit can perform efficient analysis by determining the priority of analysis based on the submission time of data. Part or all of the above-described processing in the analysis unit may be performed using, for example, AI, or may be performed without using AI. For example, the analysis unit can input the submission time of data into generative AI and cause the generative AI to execute the determination of the priority of analysis. Specifically, the present analysis unit implements priority control logic using freshness of data as an evaluation function. The present analysis unit gives a higher weight to data with a shorter elapsed time from data generation time, and inputs the data into a real-time analysis pipeline (stream processing). Data for which a certain time or more has elapsed is accumulated and then processed in a batch analysis pipeline (Hadoop/Spark, etc.). When using generative AI, the present analysis unit inputs a timestamp and content variability of data, causes the generative AI to determine “whether this data needs to be analyzed right now or can be analyzed collectively later,” and distributes a processing route (hot path/cold path) based on the determination. This produces a technical effect of preventing analysis delay of data for which immediacy has value, such as market prices and disaster information.

The analysis unit can adjust an order of analysis based on relevance of data at a time of analysis. For example, the analysis unit preferentially analyzes highly relevant data. For example, the analysis unit postpones data with low relevance. For example, the analysis unit adjusts the order of analysis in stages according to the relevance. Accordingly, the analysis unit can perform efficient analysis by adjusting the order of analysis based on the relevance of data. Part or all of the above-described processing in the analysis unit may be performed using, for example, AI, or may be performed without using AI. For example, the analysis unit can input the relevance of data into generative AI and cause the generative AI to execute the adjustment of the order of analysis. Specifically, the present analysis unit manages dependency relationships and semantic connections between data as a graph structure (Dependency Graph). When an analysis result of certain data A is necessary for analysis of data B, or when data A and data B are related to the same topic (e.g., a specific event), the present analysis unit groups them and schedules them to be analyzed continuously. Processing is performed in an order that increases a cache hit rate while resolving dependency relationships using an algorithm such as topological sorting. When using generative AI, the present analysis unit inputs metadata of an unprocessed data group, instructs the generative AI to “cluster contextually deeply related data and propose an efficient processing order,” and reconstructs an analysis queue based on the proposal. This reduces overhead of context switching and improves analysis efficiency.

The provision unit can analyze an emotion of a user and adjust a display method of information to be provided based on the analyzed emotion of the user. For example, when the user is relaxed, the provision unit provides a detailed display method. For example, when the user is busy, the provision unit provides a concise display method. For example, when the user is excited, the provision unit provides a visually stimulating display method. Accordingly, the provision unit can perform appropriate display by adjusting the display method of information to be provided according to the emotion of the user. Estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the provision unit may be performed using, for example, AI, or may be performed without using AI. For example, the provision unit can input emotion data of the user into generative AI and cause the generative AI to execute the adjustment of the display method. Specifically, the present provision unit is equipped with an Adaptive User Interface (UI) generation system, and changes properties of screen components (widgets) in real time according to the emotion state of the user. When the user is “relaxed,” the present provision unit adopts a grid layout that displays information comprehensively, and reduces a font size to increase information density. When the user is “busy,” the present provision unit adopts a card-type layout and switches to a “summary mode” that displays only important numerical values and conclusions in a large size. When the user is “excited,” dynamic effects using animation effects and vivid colors are added. When using generative AI, the present provision unit inputs data to be displayed and the user emotion, causes the generative AI to generate “HTML/CSS code of a dashboard tailored to the user's mood,” and causes the browser to render the code. This realizes information transmission optimized for the psychological characteristics of the user.

The provision unit can adjust a degree of detail of provision based on an importance of information at a time of provision. For example, the provision unit provides highly important information in detail. For example, the provision unit provides information with low importance simply. For example, the provision unit adjusts the degree of detail of provision in stages according to the importance. Accordingly, the provision unit can perform efficient provision by adjusting the degree of detail of provision based on the importance of information. Part or all of the above-described processing in the provision unit may be performed using, for example, AI, or may be performed without using AI. For example, the provision unit can input the importance of information into generative AI and cause the generative AI to execute the adjustment of the degree of detail of provision. Specifically, the present provision unit has a function of automatically generating a hierarchical structure (drill-down structure) of information based on an importance score of information. For highly important information (e.g., emergency alerts, KPIs not achieving targets), the present provision unit directly displays detailed graphs and analysis comments on a top page. Information with low importance is placed behind a collapsible menu or a link, and details are displayed only when the user explicitly operates (progressive disclosure). When using generative AI, the present provision unit inputs original data and importance, causes the generative AI to generate “summary sentences according to importance (100 characters, 300 characters, 1000 characters),” and selects and displays text of an appropriate length according to space on the UI and importance. This prevents information overload on the screen and reduces a risk that the user overlooks important information.

The provision unit can apply a different provision algorithm according to a category of information at a time of provision. For example, the provision unit applies an image display algorithm to image information. For example, the provision unit applies an audio playback algorithm to audio information. For example, the provision unit applies a video playback algorithm to video information. Accordingly, the provision unit can perform appropriate provision by applying a different provision algorithm according to the category of information. Part or all of the above-described processing in the provision unit may be performed using, for example, AI, or may be performed without using AI. For example, the provision unit can input the category of information into generative AI and cause the generative AI to execute the application of the provision algorithm. Specifically, the present provision unit is equipped with a multimodal output generation engine, and selects an optimal presentation layer according to a format of data. In the case of text information, the present provision unit formats it into easy-to-read sentences using Natural Language Generation (NLG) technology, and provides it as voice using a Text-to-Speech (TTS) engine as necessary. In the case of numerical data, the present provision unit analyzes characteristics of data (time series, distribution, comparison), and automatically selects and draws an optimal graph type (line, bar, scatter plot, heat map). When using generative AI, the present provision unit can also drive video generation AI (Text-to-Video) using text data as input to automatically generate and provide an explanatory video. This enables the user to enjoy information in a form that can be understood most intuitively without being conscious of the format of data.

The provision unit can analyze an emotion of a user and determine a priority of information to be provided based on the analyzed emotion of the user. For example, when the user is relaxed, the provision unit preferentially provides information with high importance. For example, when the user is busy, the provision unit postpones information with low importance. For example, when the user is excited, the provision unit preferentially provides information related to the emotion. Thereby, the provision unit can preferentially provide important information by determining the priority of information to be provided according to the emotion of the user. The estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the provision unit may be performed using, for example, AI, or may be performed without using AI. For example, the provision unit can input user emotion data into the generative AI and cause the generative AI to execute the determination of the priority of information. Specifically, the provision unit includes a notification manager that controls push notifications, email distribution, and in-app feed display. This manager takes the user's emotional state as input and optimizes the distribution timing and order of information. When the user is “relaxed”, the provision unit notifies a long report or an analysis result (high importance) that should be read carefully. When the user is “busy”, the provision unit suspends notifications (silent mode) except for highly urgent alerts, and performs “digest distribution” in which notifications are made collectively later. When using generative AI, the provision unit takes an unread information list and user emotion as input, causes the generative AI to select “best 3 information to be conveyed to the current user”, and performs notification based on the selection result. This realizes smart information provision considering the user's interrupt tolerance.

The provision unit can determine a priority of provision based on a submission time of information at a time of provision. For example, the provision unit preferentially provides recently submitted information. For example, the provision unit postpones old information. For example, the provision unit adjusts the priority of provision in stages according to the submission time. Thereby, the provision unit can provide information efficiently by determining the priority of provision based on the submission time of the information. Part or all of the above-described processing in the provision unit may be performed using, for example, AI, or may be performed without using AI. For example, the provision unit can input the submission time of information into generative AI and cause the generative AI to execute the determination of the priority of provision. Specifically, the provision unit uses an algorithm that scores “freshness” of information, and places new information at the top in a timeline-style UI. Based on a difference between a generation time of information and a current time, the provision unit performs visual weighting such as lowering a display position or reducing a display size as time passes. In addition, the provision unit also has logic to recalculate the priority and display it at the top when relevance to a currently occurring event resurfaces (revival), even if the information is old. When using generative AI, the provision unit takes new arrival information and a past archive as input, causes the generative AI to generate “commentary on the latest news based on past context”, and integrates and provides old and new information. This enables information provision with context beyond mere chronological display.

The provision unit can adjust an order of provision based on relevance of information at a time of provision. For example, the provision unit preferentially provides highly relevant information. For example, the provision unit postpones information with low relevance. For example, the provision unit adjusts the order of provision in stages according to the relevance. Thereby, the provision unit can provide information efficiently by adjusting the order of provision based on the relevance of the information. Part or all of the above-described processing in the provision unit may be performed using, for example, AI, or may be performed without using AI. For example, the provision unit can input the relevance of information into generative AI and cause the generative AI to execute the adjustment of the order of provision. Specifically, the provision unit is equipped with a “next action prediction model” that predicts information to be viewed next based on content currently viewed by the user or immediate operation history. The provision unit lists highly relevant information using semantic similarity between contents (distance in vector space) or browsing transition probability of other users (Markov chain, etc.), and presents it as “read together” in a sidebar or at the bottom of an article. When using generative AI, the provision unit takes current display content and candidate content in a database as input, causes the generative AI to infer “which is the optimal material to supplement this information”, and generates a recommendation frame based on the result. This supports smooth information gathering without interrupting the user's flow of thought.

The system according to the embodiment is not limited to the above-described examples, and various modifications are possible as follows, for example. Specifically, the architecture of the present system is designed to be loosely coupled without depending on a specific hardware or software configuration, and migration to a hybrid configuration combining an on-premise server, a public cloud (AWS, Azure, GCP, etc.), and an edge device (IoT sensor, smartphone), or to a serverless architecture is also easy. In addition, since each functional unit (collection, extraction, publication, cooperation, analysis, provision) is implemented as an independent microservice, it is also possible to replace only a specific function with a third-party API or the latest AI model (for example, a higher-performance LLM or image generation model). Furthermore, the present system has flexibility capable of supporting future technological expansion such as introducing blockchain technology to guarantee authenticity of data or using a quantum computer to speed up optimization calculation.

The collection unit can also monitor a health condition of a user and adjust a timing of data collection based on the health condition. For example, when the user is tired, data collection can be postponed. When the user is healthy, data collection can be performed immediately. Thereby, the collection unit can reduce a burden on the user by adjusting the timing of data collection according to the health condition of the user. Specifically, the collection unit cooperates with a wearable device such as a smart watch or a fitness tracker via an API, and acquires vital data such as heart rate, blood pressure, sleep time, activity amount (number of steps), and electrodermal activity (EDA) in real time. The collection unit is equipped with a health condition estimation model (for example, a random forest or LSTM model that performs regression prediction of a fatigue level or a stress level) that takes these vital data as input, and quantifies the user's condition. When the estimated fatigue level exceeds a predetermined threshold, the collection unit suppresses active data collection actions such as push notifications and questionnaire requests, and switches to only passive log collection in the background. Conversely, when it is determined that the user has taken sufficient rest and the condition is good, the collection unit makes a data provision request involving a complicated operation. This realizes a healthcare-conscious system operation that considers the physical and physiological state of the user.

The extraction unit can also evaluate reliability of data and determine a priority of an element to be extracted based on the reliability. For example, an important element can be preferentially extracted from highly reliable data. Data with low reliability can be postponed. Thereby, the extraction unit can provide more accurate information by determining the priority of extraction based on the reliability of the data. Specifically, the extraction unit includes a credibility evaluation engine that calculates a credibility score (Credibility Score) of each data based on domain authority of a data source, reputation of an author, a diffusion pattern on SNS, and a collation result with a fact check database. For data with a high credibility score (for example, an announcement by a public institution or a peer-reviewed paper), the extraction unit preferentially executes detailed information extraction processing (full text analysis, structuring of numerical data) and integrates it into a knowledge graph. On the other hand, for data with a low credibility score (for example, a blog of unknown origin or an SNS post at a rumor level), the extraction unit lowers the priority of processing or attaches a “verification required” flag to isolate it. When using generative AI, the extraction unit takes the content of an article as input, causes the generative AI to analyze “logical consistency of claims included in this article and presence or absence of evidence”, and determines a risk of hallucination or fake news. This produces a technical effect of ensuring the quality and reliability of information provided by the system.

The publication unit can also evaluate visual appeal of data and adjust a display method of data to be published based on the appeal. For example, visually attractive data can be displayed in detail, and data with less appeal can be displayed briefly. Thereby, the publication unit can attract the user's interest by adjusting the display method based on the visual appeal of the data. Specifically, the publication unit applies an Aesthetic Assessment Model (e.g., NIMA: Neural IMage Assessment) to image or video data, and quantifies a “Visual Appeal Score” from viewpoints such as composition, color, lighting, and clarity. For an image with a high score (for example, a photograph of beautiful scenery or delicious-looking food), the publication unit automatically selects a layout that increases a screen occupancy rate and displays it in high resolution. For an image with a low score (for example, a blurred photograph or a dark image), the publication unit displays it as a thumbnail or applies image correction AI (super-resolution, brightness adjustment) before displaying it. When using generative AI, the publication unit takes text content as input, causes the generative AI to generate a “catchphrase that catches a reader's eye” or an “attractive eye-catching image”, and enhances the appeal of the content. This improves the user's visual satisfaction and contributes to extension of stay time and improvement of conversion rate.

The cooperation unit can also analyze an economic situation of a local government and adjust a method of cooperation based on the economic situation. For example, an active cooperation method can be proposed to a local government with economic leeway, and a cooperation method with suppressed costs can be proposed to a local government in a severe economic situation. Thereby, the cooperation unit can realize effective cooperation by adjusting the cooperation method according to the economic situation of the local government. Specifically, the cooperation unit includes a financial analysis model that collects and analyzes financial statements (revenue, expenditure, financial capability index, real debt service ratio, etc.) and open data published by each local government, and estimates financial soundness and investment capacity of the local government. For a local government with a high financial capability index and investment capacity, the cooperation unit proposes a high value-added cooperation plan including introduction of the latest AI and large-scale infrastructure development. On the other hand, for a local government with a severe financial situation, the cooperation unit proposes a low-cost and high-efficiency cooperation plan including utilization of open source software, pay-as-you-go use of cloud services, or support for subsidy application. When using generative AI, the cooperation unit takes a financial report of the local government as input, causes the generative AI to formulate an “optimal DX promotion roadmap within budget constraints”, and automatically generates a proposal with high feasibility. This builds a sustainable cooperative relationship in line with the actual situation of the local government.

The analysis unit can also consider an update frequency of data and determine a priority of analysis based on the update frequency. For example, frequently updated data can be preferentially analyzed, and data with low update frequency can be postponed. Thereby, the analysis unit can promptly provide the latest information by determining the priority of analysis based on the update frequency of the data. Specifically, the analysis unit has an update prediction engine that statistically analyzes an update history of each data source and models a probability distribution of update intervals (for example, Poisson distribution). For a data source with high update frequency (for example, stock price, traffic information, SNS trend), the analysis unit sets a polling interval short or makes a listener receiving a push notification by WebSocket or the like resident, and activates an analysis pipeline simultaneously with data arrival (event-driven processing). For a data source with low update frequency (for example, demographics, annual report), the analysis unit handles it by periodic batch processing (for example, once a day). When using generative AI, the analysis unit takes a fluctuation pattern of data as input, causes the generative AI to predict “timing when the next large change occurs”, and reserves resources according to the timing. This secures real-time property of information while suppressing consumption of useless calculation resources.

The collection unit can also analyze an emotion of a user and determine a type of data to be collected based on the analyzed emotion of the user. For example, when the user is relaxed, interesting data can be collected. When the user is busy, minimum necessary data can be collected. Thereby, the collection unit can reduce a burden on the user by determining the type of data to be collected according to the emotion of the user. Specifically, the collection unit holds a correlation matrix between an output of an emotion recognition model (emotion vector) and a data category (entertainment, news, business communication, advertisement, etc.). When the user is in a “relaxed” state, the collection unit increases a collection ratio of “exploratory data” that arouses the user's interest, such as highly entertaining video data or blog articles related to hobbies. When the user is in a “busy (high stress)” state, the collection unit narrows down to “essential data” necessary for business execution or urgent communication matters, and stops collection of information that becomes noise. When using generative AI, the collection unit takes the user's emotion and current context as input, causes the generative AI to infer a “genre of content comfortable for the current user”, and searches for and collects data matching the genre from the Web. This realizes information filtering adapted to the user's psychological receptivity.

The extraction unit can also analyze an emotion of a user and adjust a degree of detail of data to be extracted based on the analyzed emotion of the user. For example, when the user is relaxed, detailed data can be extracted. When the user is busy, concise data can be extracted. Thereby, the extraction unit can provide information according to the user's needs by adjusting the degree of detail of data to be extracted according to the emotion of the user. Specifically, the extraction unit dynamically changes a parameter controlling granularity of information in extraction processing based on the user's emotion score. When the user is “relaxed” and it is determined that information reception capacity is high, the extraction unit sets a compression rate of text summarization low (long sentence summary), and extracts many tags including details of a background from an image. When the user is “busy”, the extraction unit compresses text to “three bullet points” and extracts only a main subject from an image. When using generative AI, the extraction unit takes original data and user emotion as input, instructs the generative AI to “summarize with an optimal amount of information considering the user's cognitive load (Cognitive Load)”, and adopts the output text. This enables provision at an optimal information density according to the user's situation.

The publication unit can also analyze an emotion of a user and adjust a timing of data to be published based on the analyzed emotion of the user. For example, when the user is relaxed, data can be published immediately. When the user is busy, data can be published later. Thereby, the publication unit can improve user convenience by adjusting the timing of publication according to the emotion of the user. Specifically, the publication unit includes an intelligent distribution scheduler that controls timing of performing notification or data display to the user. This scheduler monitors the user's emotional state in real time, detects a moment when the user enters a “relaxed” state (for example, when work is paused, relaxing time after returning home), and collectively publishes and notifies accumulated data (news, recommended information, etc.). While the user is in a “concentrated” or “busy” state, the publication unit buffers (temporarily saves) data to avoid interruption. When using generative AI, the publication unit takes the user's life pattern and emotion history as input, causes the generative AI to predict a “time zone when the user is most likely to accept information”, and makes a distribution reservation according to the time zone. This realizes distribution control that increases a reach rate of information without hindering user experience.

The cooperation unit can also analyze an emotion of the local government and determine a type of project for cooperation based on the analyzed emotion. For example, when the local government is relaxed, a long-term project can be proposed. When the local government is busy, a short-term project can be proposed. Thereby, the cooperation unit can realize effective cooperation by determining the type of project according to the emotion of the local government. Specifically, the cooperation unit has an organizational emotion analysis model that estimates “atmosphere” or “morale” of a local government organization from text analysis of published minutes or a communication log with a person in charge. When it is determined that the entire organization is in a “relaxed (stable, positive)” state, the cooperation unit proposes a large-scale project requiring resources and time, such as a smart city concept or long-term tourism branding. When the organization is in a “busy (confused, exhausted)” state, the cooperation unit proposes a small-scale project (Quick Win) that produces results in a short period of time, such as operational efficiency improvement by RPA (Robotic Process Automation) or event attraction support with immediate effect. When using generative AI, the cooperation unit takes current issues and organizational emotion of the local government as input, and causes the generative AI to generate a “project plan that is executable without unreasonableness under the current organizational structure and is effective”. This realizes realistic cooperation matching the reception capacity of the local government.

The analysis unit can also analyze an emotion of a user and adjust a method of providing an analysis result based on the analyzed emotion of the user. For example, when the user is relaxed, a detailed analysis result can be provided. When the user is busy, a concise analysis result can be provided. Thereby, the analysis unit can provide information according to the user's needs by adjusting the method of providing the analysis result according to the emotion of the user. Specifically, the analysis unit passes a user emotion parameter to a formatter that determines an output format of the analysis result. When the user is “relaxed”, the analysis unit provides a full package including a detailed CSV file containing raw data, a multifaceted graph, and a detailed consideration report. When the user is “busy”, the analysis unit provides one slide extracting only important insights or a short text message describing only a conclusion. When using generative AI, the analysis unit takes a complicated analysis result (numerical data) and user emotion as input, instructs the generative AI to “create an explanatory text with a tone and manner (e.g., encouraging tone, businesslike tone) matching the user's psychological state”, and presents the output to the user. This promotes utilization of data by optimizing how to convey it to the user in addition to the value of the data itself.

A flow of processing of Example of the Embodiment will be briefly described below. Specifically, a data processing pipeline in the present system is defined as a workflow consisting of a series of sequential processing and parallel processing, and each step is executed as a stateless function or microservice. The entire control is orchestrated by a workflow engine (for example, Apache Airflow or AWS Step Functions), and a completion status, error handling, and retry processing of each step are strictly managed. The steps shown below represent a logical data flow, and in actual implementation, throughput improvement by pipeline processing and latency reduction by distributed processing are attempted.

Step 1: The collection unit collects data. The collection unit collects data from a data source on the Internet, for example. The collection unit can collect data from a news site, SNS, a blog, Yahoo, a messenger application, or the like. Specifically, a crawler issues an HTTP request based on a target URL list, acquires HTML or JSON data, and saves it in a data lake (S3, etc.). Step 2: The extraction unit extracts an element from the collected data. The extraction unit extracts an element such as a keyword, a feature amount, or a pattern from the collected data, for example. The extraction unit can extract a keyword from text data using natural language processing technology. Specifically, the extraction unit reads saved raw data, applies an NLP model or an image recognition model, generates structured metadata (entity, category, feature vector), and stores it in a database. Step 3: The publication unit publishes the extracted data on the Internet. The publication unit publishes data using a platform such as a website, SNS, or a database, for example. The publication unit can post data on a website and make it accessible to anyone. Specifically, the publication unit distributes structured data as a Web page or a JSON response to an external client through a CMS or an API server. Step 4: The cooperation unit handles cooperation with a local government. The cooperation unit implements a joint project with a local government, for example, and collects and publishes data for disseminating local charm. The cooperation unit can perform API cooperation with a local government and share data. Specifically, the cooperation unit synchronizes data with a local government system via a secure data exchange infrastructure and makes it mutually usable. Step 5: The analysis unit analyzes the collected data by AI. The analysis unit analyzes data using technology such as machine learning, deep learning, or natural language processing, for example. The analysis unit can analyze the collected data by AI and extract a feature of the data. Specifically, the analysis unit executes batch analysis or stream analysis on accumulated big data, and calculates a trend prediction or a clustering result. Step 6: The provision unit provides an analysis result. The provision unit provides the analysis result in a form of a report, a graph, statistical data, or the like, for example. The provision unit can post the analysis result on a website and make it accessible to anyone. Specifically, the provision unit visualizes the analysis result through a BI tool or a dashboard and presents it in a form that supports user's decision making.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of a plurality of elements including the above-described collection unit, extraction unit, publication unit, cooperation unit, analysis unit, and provision unit is realized by, for example, at least one of a smart device 14 and a data processing apparatus 12. For example, the collection unit collects data from a data source on the Internet via a communication I/F 44 of the smart device 14. The extraction unit extracts an element from the collected data by, for example, a specific processing unit 290 of the data processing apparatus 12. The publication unit publishes the extracted data on the Internet by, for example, a control unit 46A of the smart device 14. The cooperation unit handles cooperation with a local government by, for example, the specific processing unit 290 of the data processing apparatus 12. The analysis unit analyzes the collected data by AI by, for example, the specific processing unit 290 of the data processing apparatus 12. The provision unit provides the analysis result by, for example, the control unit 46A of the smart device 14. The correspondence relationship between each unit and the device or the control unit is not limited to the above-described example, and various modifications are possible.

### Second Embodiment

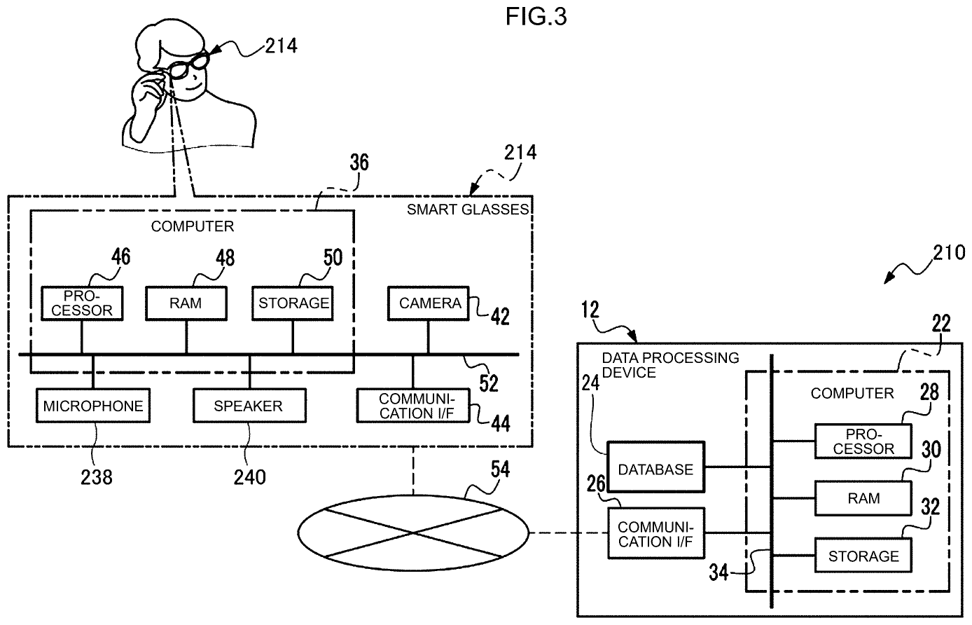

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

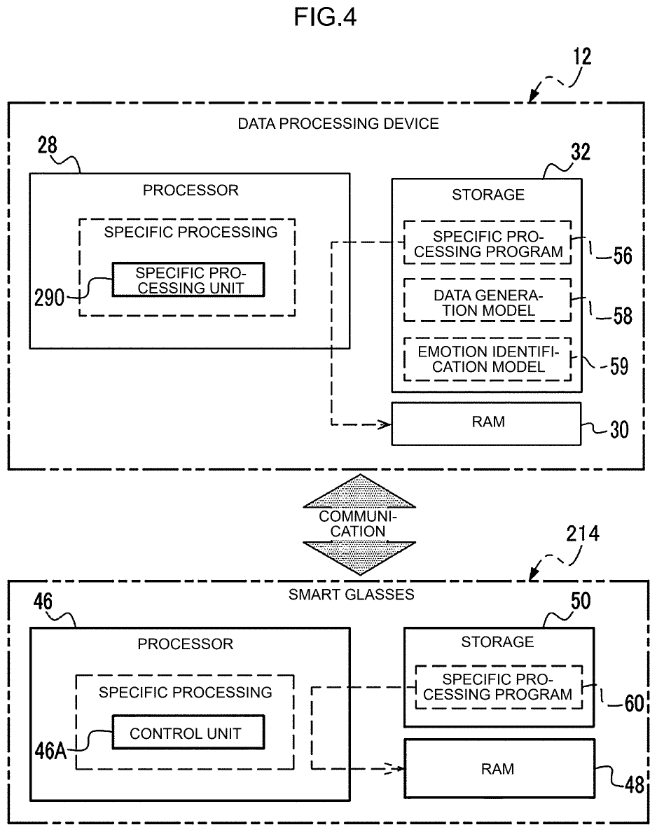

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of a plurality of elements including the above-described collection unit, extraction unit, publication unit, cooperation unit, analysis unit, and provision unit is realized by, for example, at least one of smart glasses 214 and a data processing apparatus 12. For example, the collection unit collects data from a data source on the Internet via a communication I/F 44 of the smart glasses 214. The extraction unit extracts an element from the collected data by, for example, a specific processing unit 290 of the data processing apparatus 12. The publication unit publishes the extracted data on the Internet by, for example, a control unit 46A of the smart glasses 214. The cooperation unit handles cooperation with a local government by, for example, the specific processing unit 290 of the data processing apparatus 12. The analysis unit analyzes the collected data by AI by, for example, the specific processing unit 290 of the data processing apparatus 12. The provision unit provides the analysis result by, for example, the control unit 46A of the smart glasses 214. The correspondence relationship between each unit and the device or the control unit is not limited to the above-described example, and various modifications are possible.

### Third Embodiment

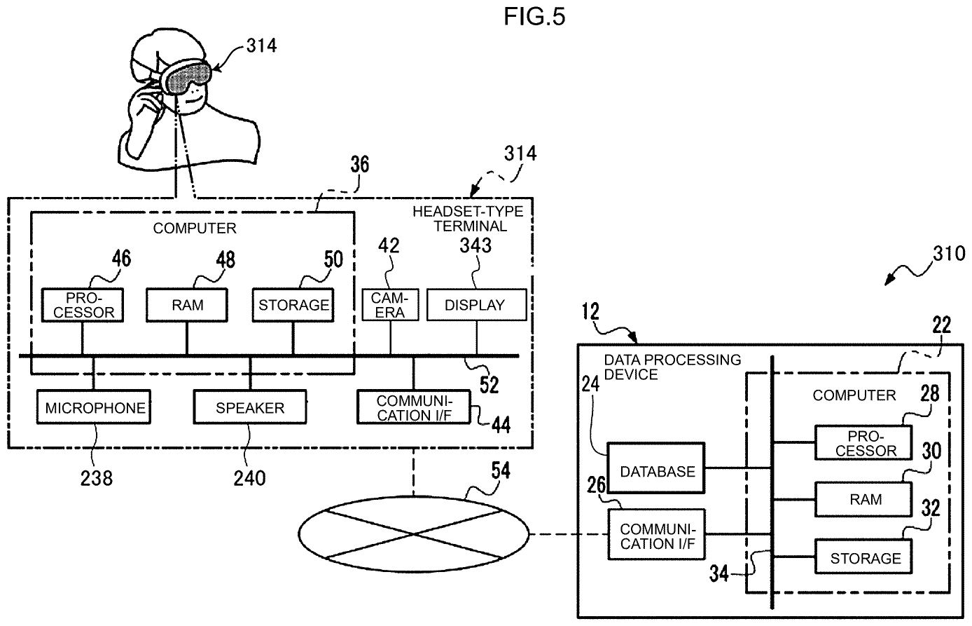

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

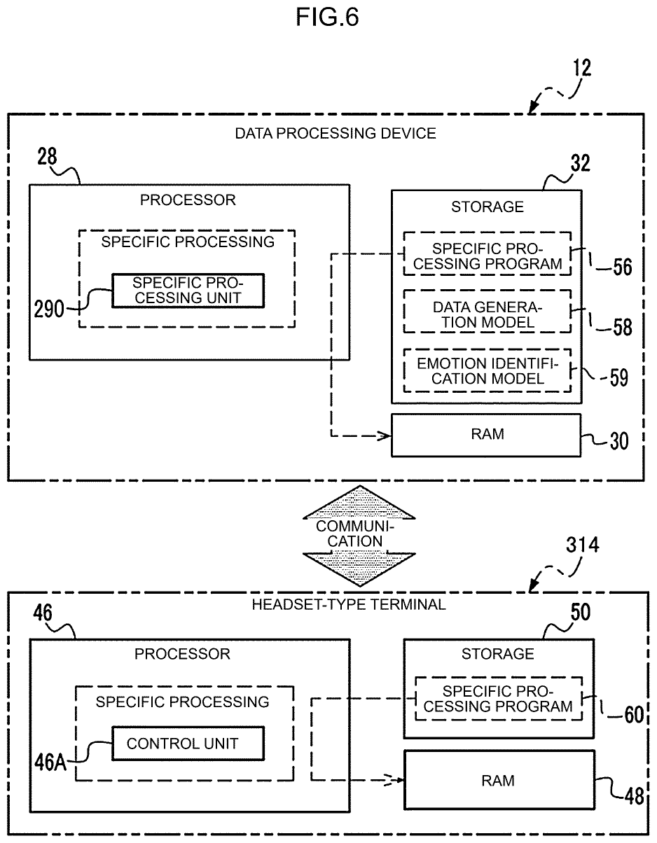

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of a plurality of elements including the above-described collection unit, extraction unit, publication unit, cooperation unit, analysis unit, and provision unit is realized by, for example, at least one of a headset-type terminal 314 and a data processing apparatus 12. For example, the collection unit collects data from a data source on the Internet via a communication I/F 44 of the headset-type terminal 314. The extraction unit extracts an element from the collected data by, for example, a specific processing unit 290 of the data processing apparatus 12. The publication unit publishes the extracted data on the Internet by, for example, a control unit 46A of the headset-type terminal 314. The cooperation unit handles cooperation with a local government by, for example, the specific processing unit 290 of the data processing apparatus 12. The analysis unit analyzes the collected data by AI by, for example, the specific processing unit 290 of the data processing apparatus 12. The provision unit provides the analysis result by, for example, the control unit 46A of the headset-type terminal 314. The correspondence relationship between each unit and the device or the control unit is not limited to the above-described example, and various modifications are possible.

### Fourth Embodiment

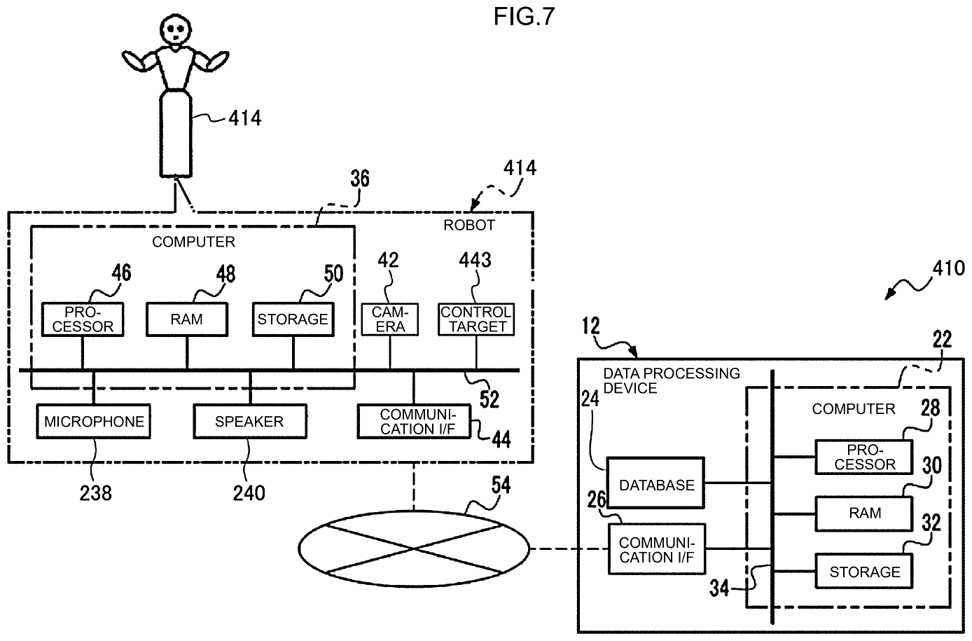

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

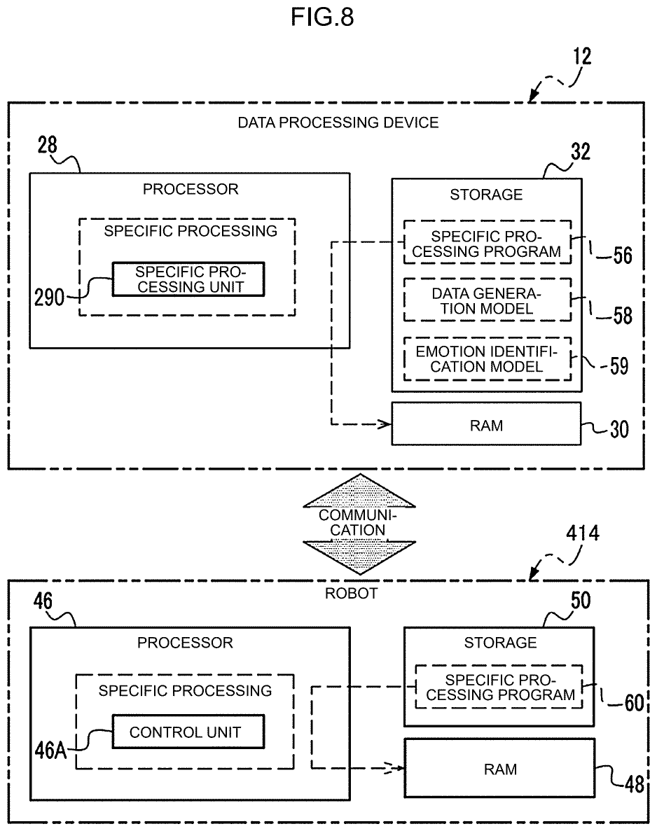

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of a plurality of elements including the above-described collection unit, extraction unit, publication unit, cooperation unit, analysis unit, and provision unit is realized by, for example, at least one of a robot 414 and a data processing apparatus 12. For example, the collection unit collects data from a data source on the Internet via a communication I/F 44 of the robot 414. The extraction unit extracts an element from the collected data by, for example, a specific processing unit 290 of the data processing apparatus 12. The publication unit publishes the extracted data on the Internet by, for example, a control unit 46A of the robot 414. The cooperation unit handles cooperation with a local government by, for example, the specific processing unit 290 of the data processing apparatus 12. The analysis unit analyzes the collected data by AI by, for example, the specific processing unit 290 of the data processing apparatus 12. The provision unit provides the analysis result by, for example, the control unit 46A of the robot 414. The correspondence relationship between each unit and the device or the control unit is not limited to the above-described example, and various modifications are possible.

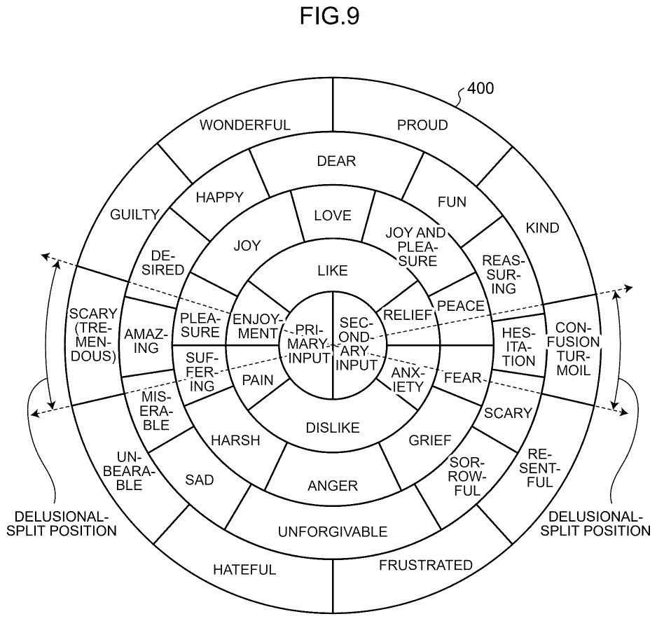

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

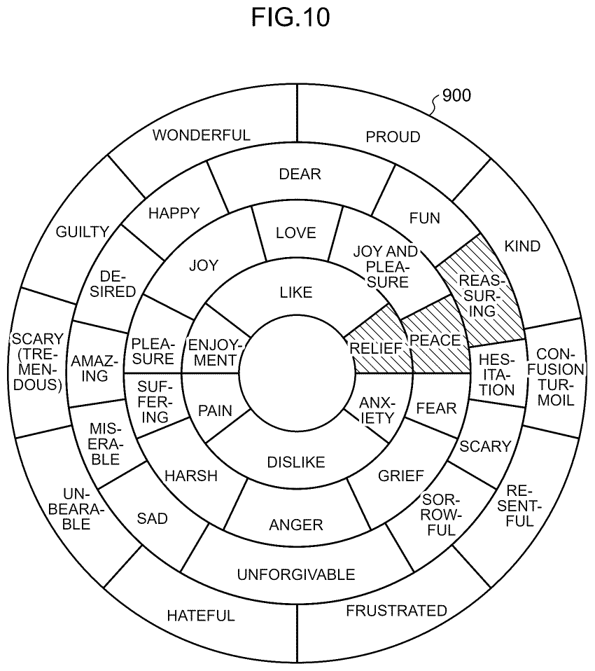

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a collection unit configured to collect data; an extraction unit configured to extract an element from the data collected by the collection unit; a publication unit configured to publish the data extracted by the extraction unit on the Internet; a cooperation unit configured to handle cooperation with a local government; an analysis unit configured to analyze, by AI, the data collected by the collection unit; and a provision unit configured to provide an analysis result obtained by the analysis unit.
(Supplementary Note 2) The system according to Supplementary Note 1, wherein the collection unit is configured to collect data from a data source on the Internet.
(Supplementary Note 3) The system according to Supplementary Note 1, wherein the extraction unit is configured to extract an element from the collected data.
(Supplementary Note 4) The system according to Supplementary Note 1, wherein the publication unit is configured to publish the extracted data on the Internet.
(Supplementary Note 5) The system according to Supplementary Note 1, wherein the cooperation unit is configured to handle cooperation with a local government.
(Supplementary Note 6) The system according to Supplementary Note 1, wherein the analysis unit is configured to analyze the collected data by AI.
(Supplementary Note 7) The system according to Supplementary Note 1, wherein the provision unit is configured to provide the analysis result.
(Supplementary Note 8) The system according to Supplementary Note 1, wherein the collection unit is configured to analyze an emotion of a user and adjust a timing of data collection based on the analyzed emotion of the user.
(Supplementary Note 9) The system according to Supplementary Note 1, wherein the collection unit is configured to analyze a past data provision history of a user and select an appropriate collection method.
(Supplementary Note 10) The system according to Supplementary Note 1, wherein the collection unit is configured to perform filtering based on a current field of interest of a user at a time of data collection.
(Supplementary Note 11) The system according to Supplementary Note 1, wherein the collection unit is configured to analyze an emotion of a user and determine a priority of data to be collected based on the analyzed emotion of the user.
(Supplementary Note 12) The system according to Supplementary Note 1, wherein the collection unit is configured to preferentially collect highly relevant data in consideration of geographical location information of a user at a time of data collection.
(Supplementary Note 13) The system according to Supplementary Note 1, wherein the collection unit is configured to analyze social media activity of a user and collect related data at a time of data collection.
(Supplementary Note 14) The system according to Supplementary Note 1, wherein the extraction unit is configured to analyze an emotion of a user and determine a priority of an element to be extracted based on the analyzed emotion of the user.
(Supplementary Note 15) The system according to Supplementary Note 1, wherein the extraction unit is configured to adjust a degree of detail of extraction based on an importance of data at a time of extraction.
(Supplementary Note 16) The system according to Supplementary Note 1, wherein the extraction unit is configured to apply a different extraction algorithm according to a category of data at a time of extraction.
(Supplementary Note 17) The system according to Supplementary Note 1, wherein the extraction unit is configured to analyze an emotion of a user and adjust a display method of an element to be extracted based on the analyzed emotion of the user.
(Supplementary Note 18) The system according to Supplementary Note 1, wherein the extraction unit is configured to determine a priority of extraction based on a submission time of data at a time of extraction.
(Supplementary Note 19) The system according to Supplementary Note 1, wherein the extraction unit is configured to adjust an order of extraction based on relevance of data at a time of extraction.
(Supplementary Note 20) The system according to Supplementary Note 1, wherein the publication unit is configured to analyze an emotion of a user and adjust a display method of data to be published based on the analyzed emotion of the user.
(Supplementary Note 21) The system according to Supplementary Note 1, wherein the publication unit is configured to adjust a degree of detail of publication based on an importance of data at a time of publication.
(Supplementary Note 22) The system according to Supplementary Note 1, wherein the publication unit is configured to apply a different publication algorithm according to a category of data at a time of publication.
(Supplementary Note 23) The system according to Supplementary Note 1, wherein the publication unit is configured to analyze an emotion of a user and determine a priority of data to be published based on the analyzed emotion of the user.
(Supplementary Note 24) The system according to Supplementary Note 1, wherein the publication unit is configured to determine a priority of publication based on a submission time of data at a time of publication.
(Supplementary Note 25) The system according to Supplementary Note 1, wherein the publication unit is configured to adjust an order of publication based on relevance of data at a time of publication.
(Supplementary Note 26) The system according to Supplementary Note 1, wherein the cooperation unit is configured to analyze an emotion of the local government and adjust a method of cooperation based on the analyzed emotion.
(Supplementary Note 27) The system according to Supplementary Note 1, wherein the cooperation unit is configured to refer to a past cooperation history of the local government and select an appropriate cooperation method at a time of cooperation.
(Supplementary Note 28) The system according to Supplementary Note 1, wherein the cooperation unit is configured to analyze an emotion of the local government and determine a priority of cooperation based on the analyzed emotion.
(Supplementary Note 29) The system according to Supplementary Note 1, wherein the cooperation unit is configured to select an optimal cooperation method in consideration of geographical location information of the local government at a time of cooperation.
(Supplementary Note 30) The system according to Supplementary Note 1, wherein the analysis unit is configured to analyze an emotion of a user and adjust a method of analysis based on the analyzed emotion of the user.
(Supplementary Note 31) The system according to Supplementary Note 1, wherein the analysis unit is configured to adjust a degree of detail of analysis based on an importance of data at a time of analysis.
(Supplementary Note 32) The system according to Supplementary Note 1, wherein the analysis unit is configured to apply a different analysis algorithm according to a category of data at a time of analysis.
(Supplementary Note 33) The system according to Supplementary Note 1, wherein the analysis unit is configured to analyze an emotion of a user and determine a priority of analysis based on the analyzed emotion of the user.
(Supplementary Note 34) The system according to Supplementary Note 1, wherein the analysis unit is configured to determine a priority of analysis based on a submission time of data at a time of analysis.
(Supplementary Note 35) The system according to Supplementary Note 1, wherein the analysis unit is configured to adjust an order of analysis based on relevance of data at a time of analysis.
(Supplementary Note 36) The system according to Supplementary Note 1, wherein the provision unit is configured to analyze an emotion of a user and adjust a display method of information to be provided based on the analyzed emotion of the user.
(Supplementary Note 37) The system according to Supplementary Note 1, wherein the provision unit is configured to adjust a degree of detail of provision based on an importance of information at a time of provision.
(Supplementary Note 38) The system according to Supplementary Note 1, wherein the provision unit is configured to apply a different provision algorithm according to a category of information at a time of provision.
(Supplementary Note 39) The system according to Supplementary Note 1, wherein the provision unit is configured to analyze an emotion of a user and determine a priority of information to be provided based on the analyzed emotion of the user.
(Supplementary Note 40) The system according to Supplementary Note 1, wherein the provision unit is configured to determine a priority of provision based on a submission time of information at a time of provision.
(Supplementary Note 41) The system according to Supplementary Note 1, wherein the provision unit is configured to adjust an order of provision based on relevance of information at a time of provision.

What is claimed is:

1. A system comprising:
circuitry configured to:
collect multimodal data comprising at least one of image data, audio data, and text data from a plurality of data sources via a packet-switched network;
extract a feature vector from the collected multimodal data by applying a trained neural network model to the multimodal data;
distribute the extracted feature vector and associated structured data to a content distribution node via the packet-switched network;
generate, by inputting entity attribute data and a cooperation history database into a generative artificial intelligence model, structured cooperation data comprising a recommended action and a predicted outcome;
analyze the collected multimodal data by inputting the multimodal data into a classification model trained by deep learning on a multi-layer neural network to produce an inference result comprising at least one of a predicted value and a cluster label; and
transmit the inference result to a client terminal via the packet-switched network.

2. The system according to claim 1, wherein the circuitry is further configured to analyze an emotion of a user by applying an emotion identification model to at least one of facial expression data, voice waveform data, and heart rate variability data acquired from a sensor of the client terminal, and adjust a timing of the collecting of the multimodal data based on the analyzed emotion.

3. The system according to claim 1, wherein the circuitry is further configured to analyze a past data provision history of the user and select a collection method from among a plurality of collection methods based on the past data provision history by applying a reinforcement learning model that receives a user history feature vector as a state and outputs the collection method as an action.

4. The system according to claim 1, wherein the circuitry is further configured to generate a user profile vector representing a current field of interest of a user by analyzing at least one of a search history, a browsing history, and social media activity of the user, calculate a cosine similarity between the user profile vector and a content vector of data to be collected, and selectively collect data having a cosine similarity exceeding a predetermined threshold.

5. The system according to claim 1, wherein the circuitry is further configured to preferentially collect data associated with a geographical region proximate to a current position of a user by searching data sources within a geofence using a geospatial index.

6. The system according to claim 1, wherein the circuitry is further configured to model a social graph of a user using a graph neural network and identify a potential interest cluster of the user based on embedding vectors representing relationships between the user and other accounts.

7. The system according to claim 1, wherein the extracting comprises converting the text data into a fixed-length embedding vector using a Transformer-based encoder, generating a visual feature map from the image data using a convolutional neural network, and converting the audio data into a sequence of phonemes using an automatic speech recognition model.

8. The system according to claim 1, wherein the circuitry is further configured to adjust a degree of detail of the extracting based on an importance score calculated from metadata of the collected multimodal data, wherein data having an importance score equal to or greater than a threshold is processed by a first extraction model having a first computational complexity, and data having an importance score below the threshold is processed by a second extraction model having a second computational complexity lower than the first computational complexity.

9. The system according to claim 1, wherein the circuitry is further configured to apply a different extraction algorithm according to a category of the collected multimodal data, the category being determined by analyzing a MIME type or a binary header of the collected multimodal data.

10. The system according to claim 1, wherein the distributing comprises inputting the extracted feature vector and a target audience parameter into the generative artificial intelligence model to generate content comprising at least one of a title, body text, and metadata optimized for a publication destination, and transmitting the generated content to the content distribution node.

11. The system according to claim 1, wherein the circuitry is further configured to adjust an order of the distributing based on a relevance score calculated by computing a similarity between a feature vector of content currently being accessed by the user and feature vectors of other content.

12. The system according to claim 1, wherein the generating of the structured cooperation data comprises performing a similarity search on the cooperation history database using a case-based reasoning algorithm to identify a historical cooperation record associated with an entity having characteristics similar to a current target entity, and generating the recommended action based on the identified historical cooperation record.

13. The system according to claim 1, wherein the circuitry is further configured to perform sentiment analysis on communication data received from an external entity by natural language processing, estimate an organizational emotion state of the external entity based on the sentiment analysis, and adjust a cooperation method based on the estimated organizational emotion state.

14. The system according to claim 1, wherein the circuitry is further configured to vectorize geographical location information of an external entity using a geographic information system and identify a group of entities that are geographically proximate by applying a spatial clustering algorithm to the vectorized geographical location information.

15. The system according to claim 1, wherein the analyzing comprises inputting time-series data into a sequence transformation model comprising at least one of a long short-term memory network and a Transformer to produce the predicted value and a confidence interval associated with the predicted value.

16. The system according to claim 1, wherein the circuitry is further configured to apply a different analysis algorithm according to a modality of the collected multimodal data by dynamically loading a trained model from a model repository, wherein the image data is analyzed using a convolutional neural network, the text data is analyzed using a large language model, and time-series numerical data is analyzed using at least one of an autoregressive integrated moving average model and a long short-term memory network.

17. The system according to claim 1, wherein the circuitry is further configured to analyze an emotion of a user by applying an emotion identification model, and adjust a display method of the inference result transmitted to the client terminal based on the analyzed emotion, the adjusting comprising selecting one of a plurality of user interface layouts corresponding to different emotion states.

18. A system comprising:
a communication interface configured to communicate with a client terminal via a packet-switched network, the client terminal comprising at least one of a smart device, smart glasses, a headset-type terminal, and a robot;
a processor;
a random-access memory;
a memory storing a data generation model obtained by deep learning on a neural network and an emotion identification model;
a database; and
circuitry configured to:
collect multimodal data comprising image data, audio data, and text data from a plurality of data sources via the communication interface by issuing requests in parallel and inputting responses into a distributed message queue;
extract a feature vector from the collected multimodal data by applying the data generation model, the extracting comprising converting the text data into a fixed-length embedding vector using a Transformer-based encoder, generating a visual feature map from the image data using a convolutional neural network, and converting the audio data into a sequence of phonemes using an automatic speech recognition model;
store the extracted feature vector and associated structured metadata in the database;
distribute the extracted feature vector and the associated structured metadata from the database to a content distribution node via the communication interface;
generate, by inputting entity attribute data and a cooperation history stored in the database into a generative artificial intelligence model, structured cooperation data comprising a recommended action and a predicted outcome;
analyze the collected multimodal data by inputting the multimodal data into a classification model trained by deep learning on a multi-layer neural network to produce an inference result comprising a predicted value and a cluster label;
analyze an emotion of a user of the client terminal by applying the emotion identification model to at least one of facial expression data, voice waveform data, and heart rate variability data received from the client terminal via the communication interface; and
transmit the inference result to the client terminal via the communication interface, the inference result being formatted based on the analyzed emotion of the user.

19. The system according to claim 18, wherein the circuitry is further configured to execute a recommendation algorithm comprising at least one of collaborative filtering and matrix factorization to dynamically determine a priority of the inference result to be transmitted based on a past browsing history and an interest vector of the user.

20. A method performed by circuitry of a system, the method comprising:
collecting multimodal data comprising at least one of image data, audio data, and text data from a plurality of data sources via a packet-switched network;
extracting a feature vector from the collected multimodal data by applying a trained neural network model to the multimodal data;
distributing the extracted feature vector and associated structured data to a content distribution node via the packet-switched network;
generating, by inputting entity attribute data and a cooperation history database into a generative artificial intelligence model, structured cooperation data comprising a recommended action and a predicted outcome;
analyzing the collected multimodal data by inputting the multimodal data into a classification model trained by deep learning on a multi-layer neural network to produce an inference result comprising at least one of a predicted value and a cluster label; and
transmitting the inference result to a client terminal via the packet-switched network.
